(19) United States
(12) Patent Application Publication
(10) Pub. No.: US 2005/0267898 A1
(43) Pub. Date: Dec. 1, 2005

(54) Data format and method for communicating data associated with utility applications, such as for electric, gas, and water utility applications

(76) Inventors: Robert Simon, Rathdrum, ID (US); Robert Gay, Spokane, WA (US)

Correspondence Address: PERKINS COIE LLP;PATENT-SEA, P.O. BOX 1247, SEATTLE, WA, 98111-1247, US

(21) Appl. No.: 10/897,586

(22) Filed: Jul. 23, 2004

Related U.S. Application Data
(60) Provisional application No. 60/575,483, filed on May 28, 2004.

(51) Int. Cl. G06F 7/00

(52) U.S. Cl. 707/100

(57) ABSTRACT

A supporting system and a utility system communicate data formatted to allow for the use of customized tags that enable the definition, validation, and interpretation of data communicated between the utility and the supporting system via an electronic data transmission channel. The data format is applicable across multiple applications and multiple electronic data transmission channels. The data communicated to the supporting system may include requests for work to be performed and supporting data to be used in completing the requests for work. Data communicated to the utility system may include utility meter data, field service results, and/or analytical data resulting from raw data analysis performed by the supporting system. Once received the formatted data is validated based on a definition of the data format.

### CROSS-REFERENCE TO RELATED APPLICATION

This application claims priority to U.S. Provisional Application No. 60/575,483 (Attorney Docket No. 101458017US) filed May 28, 2004, which is herein incorporated by reference.

### BACKGROUND

A typical utility provider (e.g., electrical utility, gas utility, water utility, etc.) is often responsible for managing multiple meters that provide information about utility usage by its customers. Management of utility meters may include tasks such as meter reading and meter servicing. Such meters are typically read and/or serviced on a periodic basis.

To facilitate meter reading and servicing, utility providers may implement a variety of meter management techniques such as electronic meter reading (EMR), off-site meter reading (OMR), and automatic meter reading (AMR), some or all of which may include computerized or automated functionality. For example, with EMR, handheld computers or other electronic field devices with integrated meter reading software may be used to capture and store meter reading data from electric, gas, or water meters. Additionally, EMR systems may collect non-meter reading information, including meter condition, hazardous conditions, tamper information, survey data, and high/low reading checks. Typically, with EMR, a meter reader walks a specified route, visually reading meters and entering meter reading data into the electronic field device (e.g., handheld computer). The meter reading data is recorded and stored in the handheld computer. The meter reading data is eventually transferred to a host processor, which then transfers the data to a utility billing system, etc. EMR systems can also incorporate readings gathered by probing meters, as is the case with time-of-use meters and interval data recorders. EMR systems can also probe water meters using inductive probes, etc.

OMR uses radio-equipped handheld computers to read module-equipped electric, gas, or water meters via radio. This enables the meter to be read without directly accessing the meter or the premise. With OMR, as a meter reader walks a route, the radio-equipped handheld computer sends a radio “wake-up” signal to nearby radio-based meter modules installed on electric, gas, or water meters. There are also bubble-up techniques where the radio-based meter modules send the information at some configurable time interval (e.g., every five seconds). The handheld computer then receives meter reading and tamper data back from the meter modules. OMR is normally used to read meters within a utility service territory that are otherwise hazardous or costly to read. Such meters are typically located in a geographically dispersed environment, for example, scattered throughout the service territory.

Mobile AMR (MAMR) uses vehicles equipped with radio units to read electric, gas, or water meters equipped with receiver/transmitter modules. Meter reading can then take place via radio without the need to access the meter. A radio transceiver is installed in a utility vehicle and route information is specified. While being driven along the specified meter reading route, the transceiver broadcasts a radio wake-up signal to all radio-based meter modules within its range and receives messages in response. Completed reads may be uploaded to a billing system. Mobile AMR is usually used in saturated areas where there may be difficult-to-access or hazardous-to-read meters or large populations. Like OMR, mobile AMR can use both wake-up and bubble-up techniques for transmission of data.

Fixed network AMR uses a fixed radio communication network to collect data from electric, gas, or water meters equipped with radio-based meter modules. The collected data is transported over a wide-area communication network to a central host processor. Control units installed on power poles or street lights function as neighborhood concentrators that read meter modules, process data into a variety of applications, store data temporarily, and periodically transport data to the host processor.

Fixed network AMR is usually installed over saturated areas where advanced metering data, variable reads, and unscheduled reads are needed. Saturated deployment spreads the cost of the network components over multiple meters.

Once meter data is collected (including utility use data, meter servicing data, and tamper data), transferring this information back to the utility becomes very important. Likewise, providing information from the utility to the data collection systems (and other supporting systems) may also be necessary. Traditionally, meter reading systems use flat file data formats to interface between meter data collection systems and utility mainframe systems. Because of the complexity and variety of data involved, flat file formats can have several disadvantages when used for meter data, including disadvantages relating to system support, modification, and development.

### BRIEF DESCRIPTION OF THE DRAWINGS

FIG. 1 is a block diagram showing an example of a system on which the method and data model for communicating meter reading, field service, and other data can be implemented in one embodiment.

FIG. 2 is flow diagram showing the creation and formatting of data to be imported from the utility mainframe to the supporting system of FIG. 1.

FIG. 3A is a flow diagram showing the import of data to the supporting system of FIG. 1.

FIG. 3B is a flow diagram showing the export of data from the supporting system of FIG. 1.

FIG. 4 is a data diagram showing an example of a hierarchy in an XML definition in one embodiment.

FIG. 5 is a schema diagram of an example of an Import root node and its associated elements in one embodiment.

FIG. 6 is a schema diagram of an Export root node and its associated elements in one embodiment.

FIG. 7 is a schema diagram of a Codes node and its associated elements in one embodiment.

FIG. 8 is a schema diagram of a Messages node and its associated elements in one embodiment.

FIG. 9 is a schema diagram of a Messages node and its associated elements in one embodiment.

FIGS. 10A-10C collaboratively show a schema diagram of a WorkSet node and its associated elements in one embodiment.

FIGS. 11A-11C collaboratively show a schema diagram of a Work node and its associated elements in one embodiment.

FIG. 12 shows a schema diagram of a Customer node and its associated elements in one embodiment.

FIGS. 13A-13B collaboratively show a schema diagram of an Account node and its associated elements in one embodiment.

FIGS. 14A-14B collaboratively show a schema diagram of a ServicePoint node and its associated elements in one embodiment.

FIGS. 15A-15C collaboratively show a schema diagram of a Meter node and its associated elements in one embodiment.

FIGS. 16A-16D collaboratively show a schema diagram of a MeterSessionInput node and its associated elements in one embodiment.

FIGS. 17A-17C collaboratively show a schema diagram of a MeterSessionOutput node and its associated elements in one embodiment.

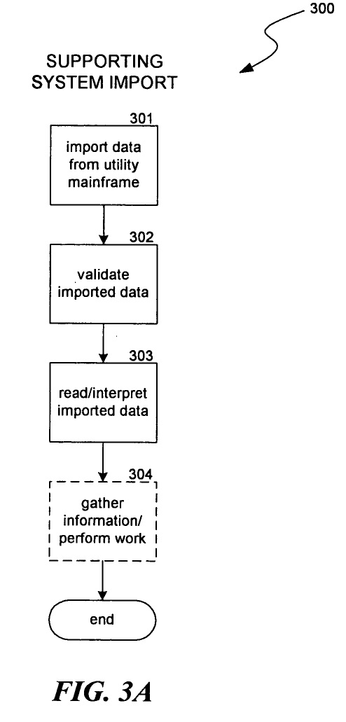

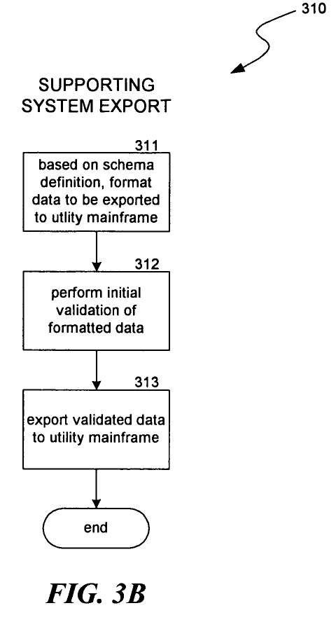

In the drawings, the same reference numbers identify identical or substantially similar elements or acts. To easily identify the discussion of any particular element or act, the most significant digit or digits in a reference number refer to the Figure number in which that element is first introduced (e.g., element 304 is first introduced and discussed with respect to FIG. 3).

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

It is intended that the terminology used in the description presented be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

I. Overview

A method, system, data model, and format for communicating meter reading, field service, and other data between relevant utility mainframe systems (sometimes referred to as “customer information systems,” or “CISs”) and data collection/processing systems (sometimes referred to as “supporting systems”) are described herein. Management of utility meters can be defined in terms of events that occur with respect to a utility infrastructure or at a utility meter or group of utility meters. For example, a meter may be read, reprogrammed, surveyed, serviced, etc. Such events may be facilitated, at least in part, through the use of one or more supporting data collection/processing systems. Once these events occur, related information (e.g., consumption data, outage data, servicing data, etc.) is then formatted and communicated back to the utility system or CIS. The utility may use the communicated information in various applications (including computer software and hardware applications), such as for customer billing, utility efficiency analysis, utility transmission analysis, utility management, etc.

In some embodiments, the data model and format utilize extensible markup language (XML), or another similar language that allows application developers to define, structure, and format documents and data using their own customized tags. In this way, data can be flexibly defined, validated, and interpreted across a wide range of applications and transmission channels. Information infrastructures that employ the data model and format can also be easily updated and modified.

A schema definition may be used to define the structure of the data model and the validation rules that apply to the transferred data. In some embodiments, this schema definition is used, at least in part, to create the format for communicating data, as well as the database schema for the systems collecting and transferring the data. The data model and format also allow the data to be broken into smaller segments that may be passed in multiple communications, as opposed to one large communication.

The channel or method of communicating the data is not restricted to file-based communication. For example, the formatted data may be passed via a message queue, standard HTTP methods, or as a parameter to a web service. It may also be written to a file and passed between systems using a file channel.

In some embodiments, the supporting system receives import data from the utility system. The received data is configured in a format that allows for the use of customized tags that enable the definition, validation, and interpretation of data communicated between the utility and the supporting system via an electronic data transmission channel. The structured data format is applicable across multiple applications and multiple electronic data transmission channels. The data itself may include requests for work to be performed by the supporting system and supporting data to be used by the supporting system in completing the requests for work. Once it receives the data, the supporting system accesses a definition of the data format and, based on the definition, validates the received data. The supporting system can then interpret the formatted data and perform work.

When exporting data back to the utility system, the supporting system identifies the information to be sent to the utility system. The information may include utility meter data (e.g., consumption reads, demand reads, TOU (time of use) reads, etc.), field service results, and/or analytical data resulting from raw data analysis performed by the supporting system. The supporting system then accesses a definition of a data format. The accessed data format allows for the use of customized tags that enable the definition, validation, and interpretation of data communicated between the utility and the supporting system via an electronic data transmission channel. The data format is applicable across multiple applications and multiple electronic data transmission channels. Based on the accessed definition, the supporting system formats the identified information to be sent to the utility system. Based on the accessed definition, the supporting system validates the formatted information to be sent to the utility system. The supporting system then transmits the validated information to the utility system.

II. System Architecture

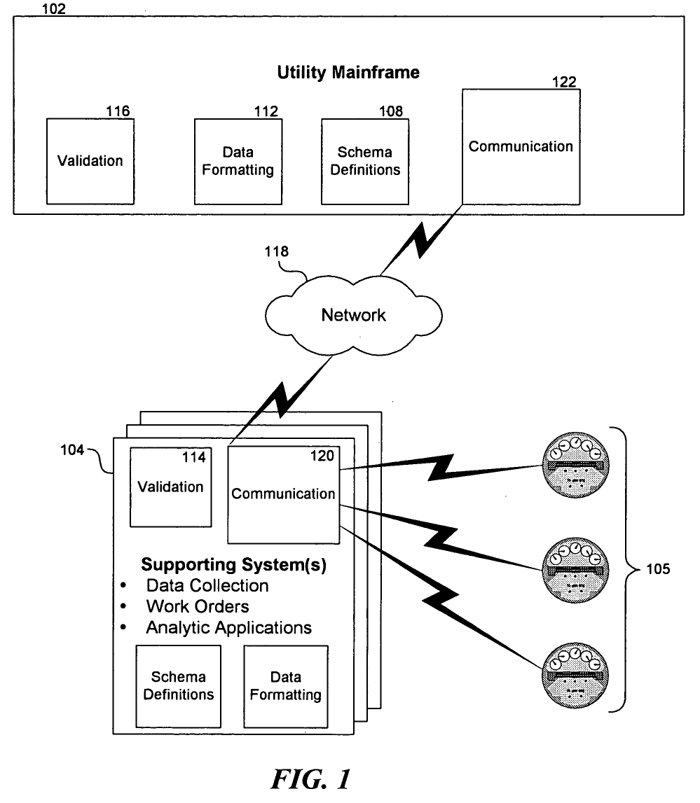

FIG. 1 and the following discussion provide a brief, general description of a suitable environment in which the invention can be implemented. Although not required, aspects of the invention are described in the general context of computer-executable instructions, such as routines executed by a general-purpose computer, e.g., a server computer, wireless device, or personal computer. Those skilled in the relevant art will appreciate that the invention can be practiced with other communications, data processing, or computer system configurations, including: Internet appliances, handheld devices (including personal digital assistants (PDAs)), wearable computers, all manner of cellular or mobile phones, multiprocessor systems, microprocessor-based or programmable consumer electronics, set-top boxes, network PCs, mini-computers, mainframe computers, and the like. Indeed, the terms “computer,” “host,” “host computer,” and “mainframe” are generally used interchangeably, and refer to any of the above devices and systems, as well as any data processor.

Aspects of the invention can be embodied in a special purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communication network. In a distributed computing environment, program modules may be located in both local and remote memory storage devices.

Aspects of the invention may be stored or distributed on computer-readable media, including magnetically or optically readable computer disks, as microcode on semiconductor memory, nanotechnology memory, or other portable data storage medium. Indeed, computer-implemented instructions, data structures, screen displays, and other data under aspects of the invention may be distributed over the Internet or over other networks (including wireless networks) or on a propagated signal on a propagation medium (e.g., an electromagnetic wave(s), a sound wave, etc.) over a period of time, or may be provided on any analog or digital network (packet switched, circuit switched or other scheme). Those skilled in the relevant art will recognize that portions of the invention reside on a server computer, while corresponding portions reside on a client computer such as a mobile device.

Referring to FIG. 1, a utility mainframe or host computer 102 communicates with one or more supporting systems 104 to operate and maintain a meter reading system 100 that allows the utility to collect information about customers' use of a utility (e.g., electric, gas, water, etc.), and perform other associated tasks. The meter reading system 100 includes one or more meters 105 maintained and read by the utility. The one or more supporting systems 104 perform tasks such as collecting meter data, managing or distributing meter service work orders, and performing analytic applications. In the illustrated embodiment, both the utility mainframe 102 and the one or more supporting systems 104 include a schema definition component (106 and 108), a data formatting component (110 and 112), and a data validation component (114 and 116) to enable the import and export of data formatted in accordance with the method and data model described herein.

In general, FIG. 1 provides an overview of the interconnections between the various components and subsystems. Communication between the utility mainframe and the one or more supporting systems 104 may take place using a variety of communication means and protocols including network communications 118 (e.g., via an intranet or the Internet). Accordingly, both the utility mainframe and the one or more supporting systems include a communication component (120 and 122) for facilitating such communication. In general, such communication components are well known in the art. However, the channel or method of communicating the data is not restricted to file-based communication. For example, the formatted data may be passed via a message queue, standard HTTP methods, or as a parameter to a web service. It may also be written to a file and passed between systems using a file channel.

III. System Flows

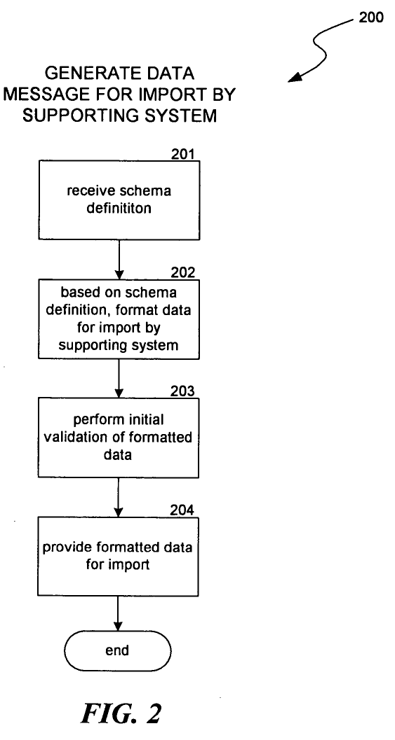

Referring to FIGS. 2 and 3A-3B, various flow diagrams show processes that occur within the components (e.g., 102 and 104) of FIG. 1. These flow diagrams do not show all functions or exchanges of data but, instead, provide an understanding of commands and data exchanged under the system. Those skilled in the relevant art will recognize that some functions or exchanges of commands and data may be repeated, varied, omitted, or supplemented, and other aspects not shown may be readily implemented. For example, while the flow diagrams show formatting data in XML, other formats for data may be used without departing from the scope of the invention.

Referring to FIG. 2, a routine 200 for generating a data message that is to be imported by the supporting system is performed at the utility mainframe of FIG. 1, or a similar system. At block 201 the utility mainframe receives a schema definition (e.g., an XML schema definition). This may be a one-time step, or may occur each time the schema is updated. The schema is what allows the utility to appropriately format information that is to be imported by the supporting system. At block 202, based on the schema definition, the routine 200 formats data to be imported by the supporting system. In an XML implementation, this would mean packaging the data in an XML format. In some embodiments, the data itself may include a request or instructions for the supporting system to perform some work. At block 203 (optional) the routine validates the formatted data to check for formatting problems and errors. At block 204, the routine 200 sends or otherwise provides the formatted data for import by the supporting system.

Referring to FIGS. 3A and 3B, the supporting system performs import/export routines (300 and 310), also based on the schema definition used by the utility mainframe in the routine of FIG. 2. Routine 300 (FIG. 3A) is an example of an import routine performed by the supporting system of FIG. 1. At block 301, the routine imports formatted XML data (e.g., a request or instructions) from the utility mainframe. At block 302, the routine performs validation on the formatted data. The validation 302 may confirm the source of the data, as well as the format and other features of the data. At block 303, the routine interprets the data. At optional block 304, the routine performs work, including gathering additional information (e.g., meter consumption data, etc.) to carry out the requests/instructions provided in the data. The routine 300 then ends.

Routine 310 (FIG. 3B) is an example of an export routine, also performed by the supporting system of FIG. 1. The routine 310 is performed so that data may be exported to the utility mainframe of FIG. 1. The exported data may include, for example, periodic reports containing meter consumption data or maintenance data, or may include specific information requested by the utility mainframe. At block 311, the routine formats the data to be exported to the utility mainframe. Like the formatting of block 202 of FIG. 2, this formatting may be based on an XML schema definition. At block 312, the routine validates the formatted data prior to export to check for formatting errors or other problems. At block 313, the routine exports the validated data to the utility mainframe. The routine then ends.

IV. Data Model

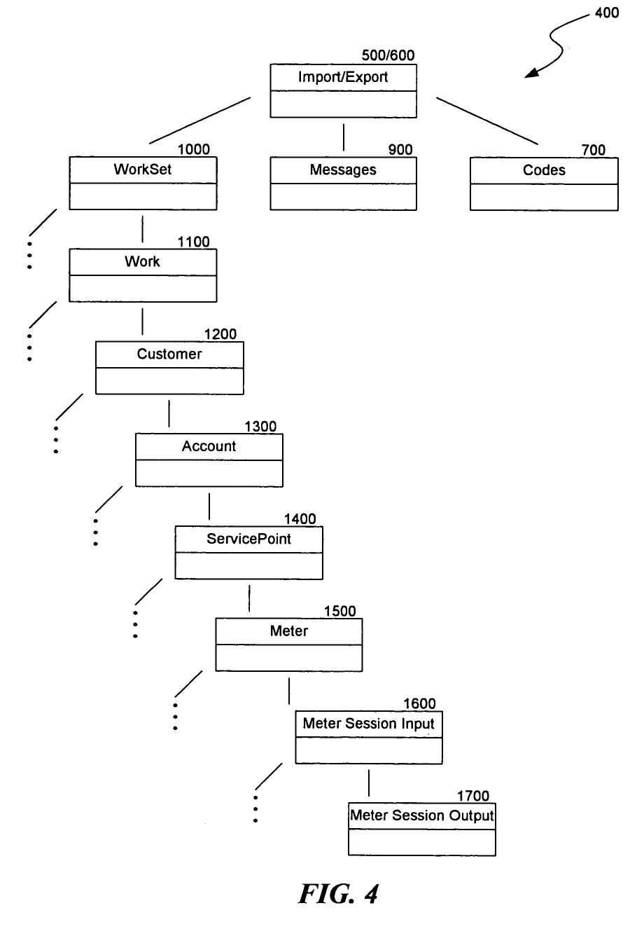

Referring to FIGS. 4-17C, schema diagrams that provide various definitions for one embodiment of the data model are shown, and the nodes of the data structure diagrams and the element names are generally self-explanatory from the Figures. Throughout this description, the terms “node” and “element” are used interchangeably. The schema diagrams generally use conventional symbols and nomenclature, and, thus, similar symbols and nomenclature have similar or identical functions. Certain nodes or elements represented by possibly less familiar symbols or nomenclature are discussed herein in more detail. Without sacrificing clarity, but for brevity, and to orient one skilled in the art to the symbols and nomenclature employed herein, certain portions of FIGS. 4-17C and other Figures herein will be discussed in detail. From the detailed discussions of certain portions and elements in selected Figures, one skilled in the relevant art can readily understand similar components in the remaining figures to understand and practice the invention.

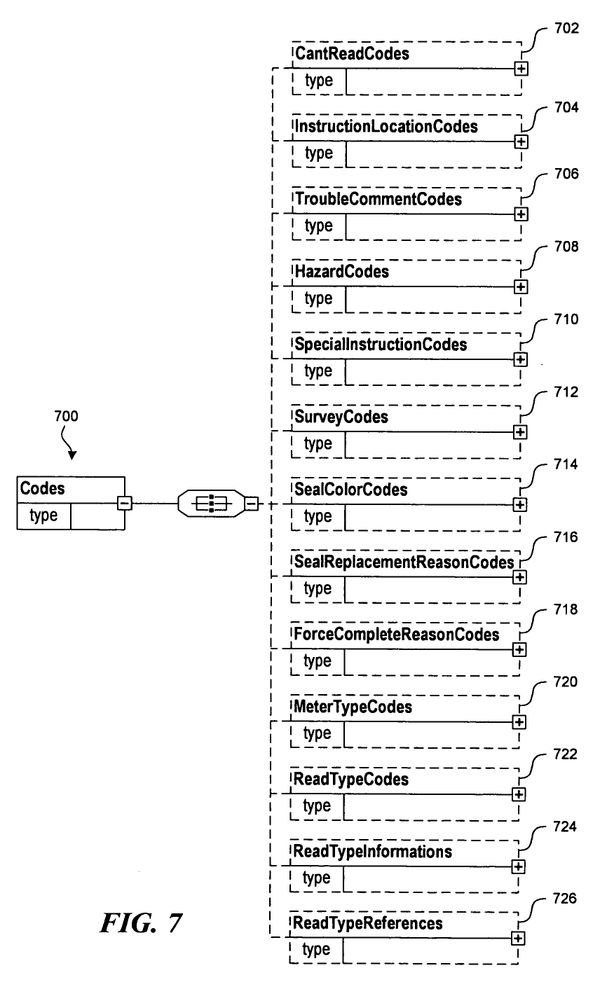

In general, the nodes of the data structure diagrams and the element names are self-explanatory. For example, the “SealReplacementReasonCodes” element 716 of FIG. 7 represents an element for storing code information identifying the reason why a seal on a utility was replaced. Where appropriate, additional explanation for some of the elements is provided in the text, and as documentation in the Figures themselves.

The data model described herein may be used as a data model for data storage (e.g., in a database), for data formatting (e.g., XML data formatting), and for other applications. More information on XML documentation standards is provided in a TDWG Working Group document entitled “Symbols used in XML Schema diagrams,” which can be found at http://160.45.63.11/Projects/TDWG-SDD/Minutes/SchemaDocu/SchemaDesiqnElements.html, and which is herein incorporated by reference. While the illustrated embodiment is implemented in XML, other similar formatting schemes may be used without departing from the scope of the invention.

Referring to FIG. 4, an overview of a schema hierarchy shows various levels of nodes and elements. Several nodes and elements are specifically identified. However, one skilled in the art would recognize that other nodes and elements, while not illustrated, may still exist. In addition, some of the nodes and elements illustrated in FIG. 4 may not be utilized in other schema examples, or may be utilized in different combinations or at different levels of the hierarchy.

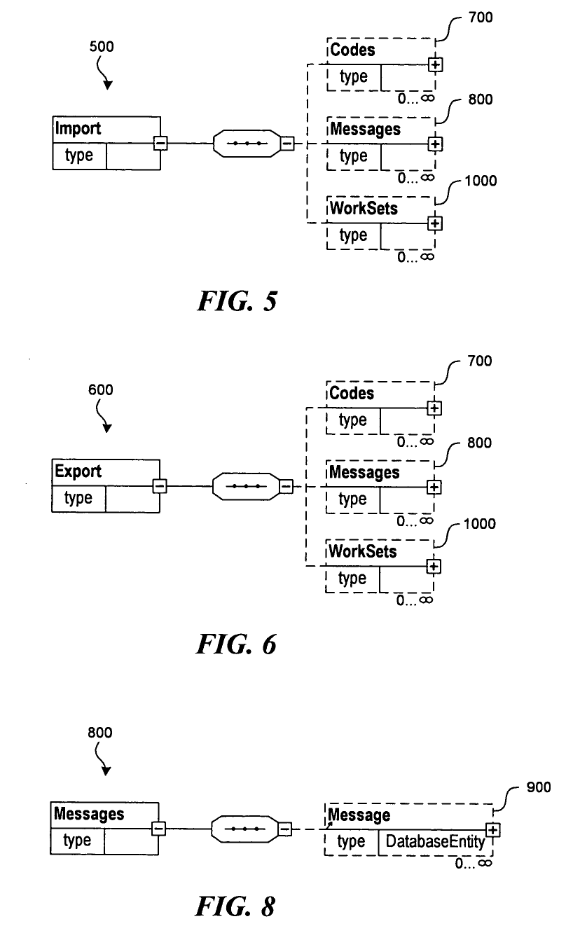

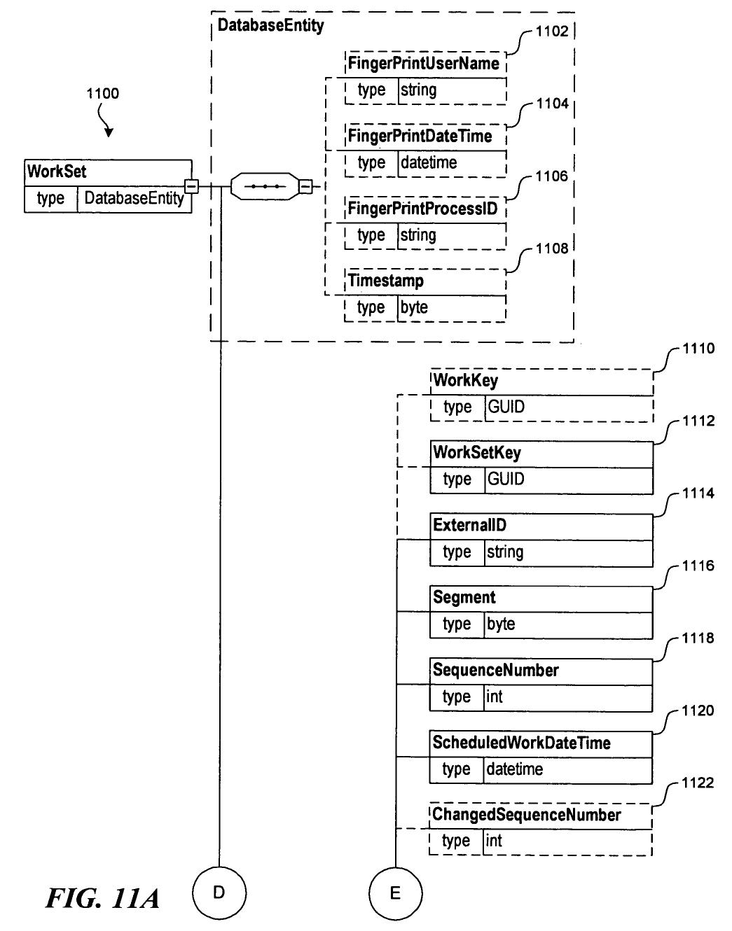

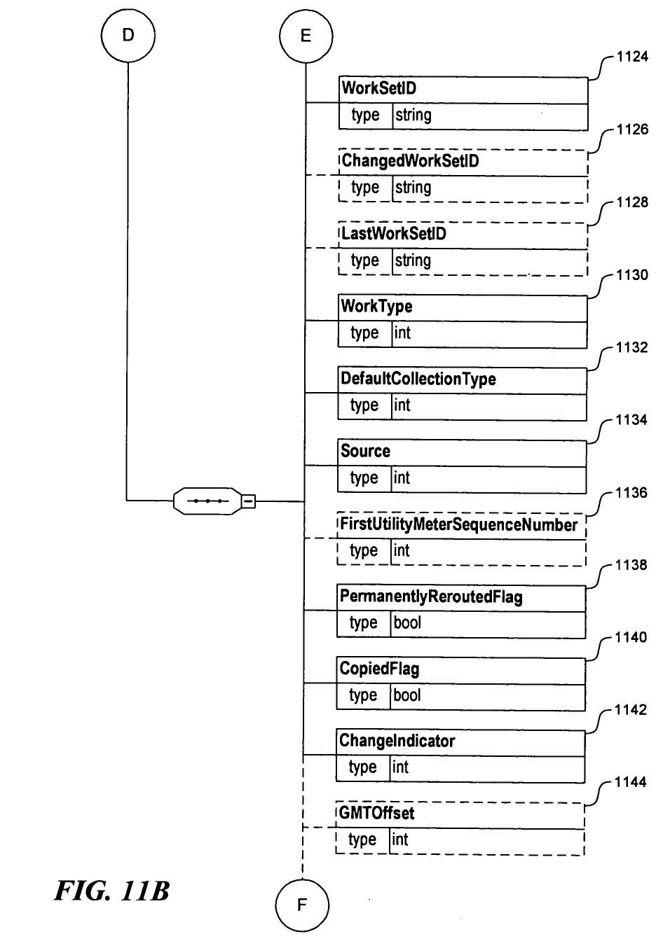

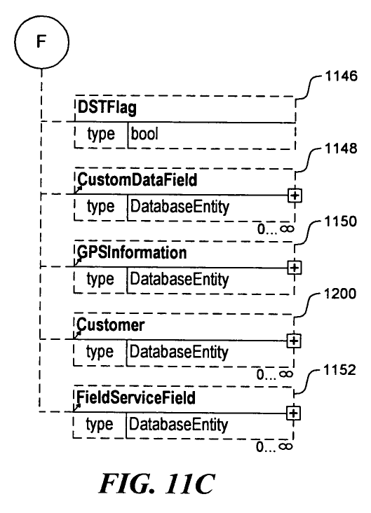

Beginning with either an Import root node or an Export root node at the top of the diagram (described in more detail with respect to FIGS. 5 and 6, respectively), the hierarchy details down to a next level having a Codes node, a Messages node, and a WorkSet node (as described in more detail with respect to FIGS. 7, 9, and 10A-10C, respectively). In the illustrated embodiment, the WorkSet node is followed by a Work node at the next level of the hierarchy (described in more detail with respect to FIGS. 11A-11C). The hierarchy continues to drill down, with the Work node 1100 being followed by a Customer node 1200, the Customer node being followed by an Account node 1300, the Account node being followed by a ServicePoint node 1400, the ServicePoint node being followed by a Meter node 1500, the Meter node being followed by a MeterSessionInput node 1600, and the MeterSessionInput node being followed by a MeterSessionOutput node 1700. While note shown in FIG. 4, subnodes/elements exist below the Messages and Codes nodes. Additional details of the hierarchy in this particular example are illustrated in the following Figures.

Referring to FIG. 5, a root import XML structure shows an “Import” root node of the data model. In some embodiments, supporting systems import data from the utility mainframe. Thus, any data imported by the supporting system from the utility mainframe may be considered import data. In the illustrated embodiment, imported information may generally include codes, messages, and work sets. For example, if the utility mainframe seeks work to be done by supporting systems or needs information from a supporting system, it creates the import XML data and passes it to the supporting system. The supporting system imports the XML data, gathers the necessary data to fulfill the request, and, where appropriate, exports the collected data to the utility mainframe in the form of XML data. An example of the format for export data is provided in FIG. 6, a root Export XML structure.

Referring to FIG. 6, the root export XML structure shows an Export root node of the data model. In the illustrated embodiment, the distinction between the import XML structure (FIG. 5) and the export XML structure is that the export XML structure contains results data (e.g., results to be communicated back to the utility mainframe) instead of request data (e.g., requests to do work). In other ways, the structure of the available elements (e.g., work sets, codes, messages, etc.) may be similar or identical. In general, work sets, codes, and messages are data that is used to support meter reading and field service use cases. As additional utility use cases are added to the supporting systems, additional elements can be added to the import and export root nodes to support the additional functionality.

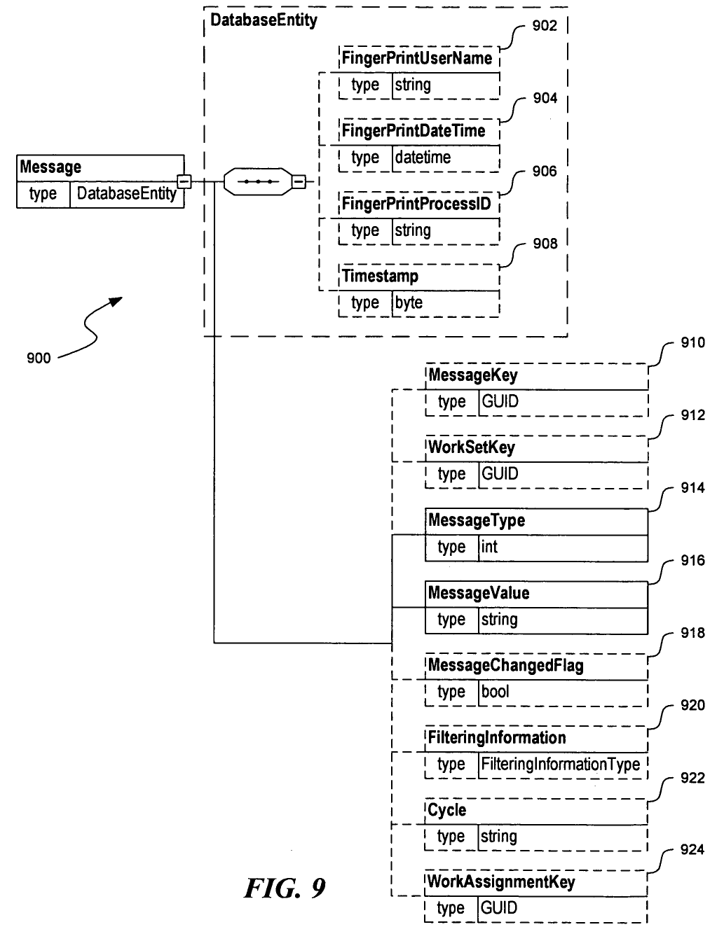

Both the import XML structure (FIG. 5) and the export XML structure (FIG. 6) may contain one or more Codes elements (FIG. 7) and one or more Messages elements (FIG. 8). These elements are containers for codes information and message information, respectively. For example, the Messages element may contain one or more message elements, as shown in FIGS. 8 and 9. Similarly, the Codes element can contain many different types of codes as shown in FIG. 7.

Referring to FIG. 7, the Codes elements can be used to structure codes being passed back and forth between the utility system and the supporting systems, as apparent from the text in the Figure. For example, a hazard code may provide an alert of a potential hazard related to reading a particular meter (e.g., a vicious dog in a customer's yard).

Referring to FIGS. 8 and 9, Messages elements may be used to structure message data being communicated between the utility system and the supporting system. As illustrated, many types of messages are possible, such as cycle messages, route messages, and district messages, etc. In the case where messages are being passed from the utility system to the supporting system, such messages may ultimately be displayed on a device (e.g., handheld computer (HHC), PC screen, etc.) associated with the supporting system.

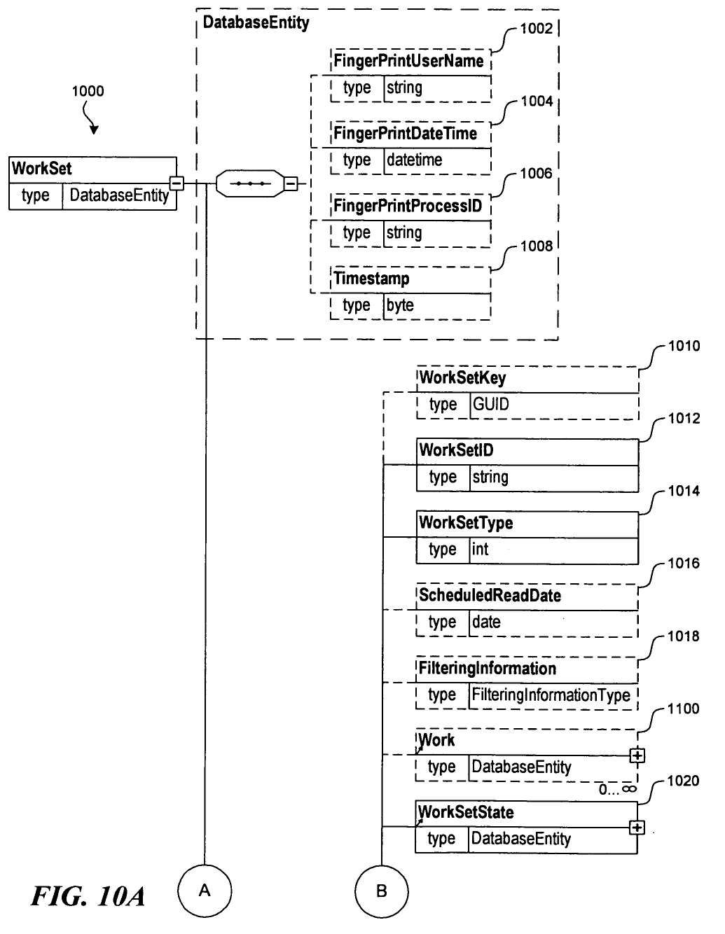

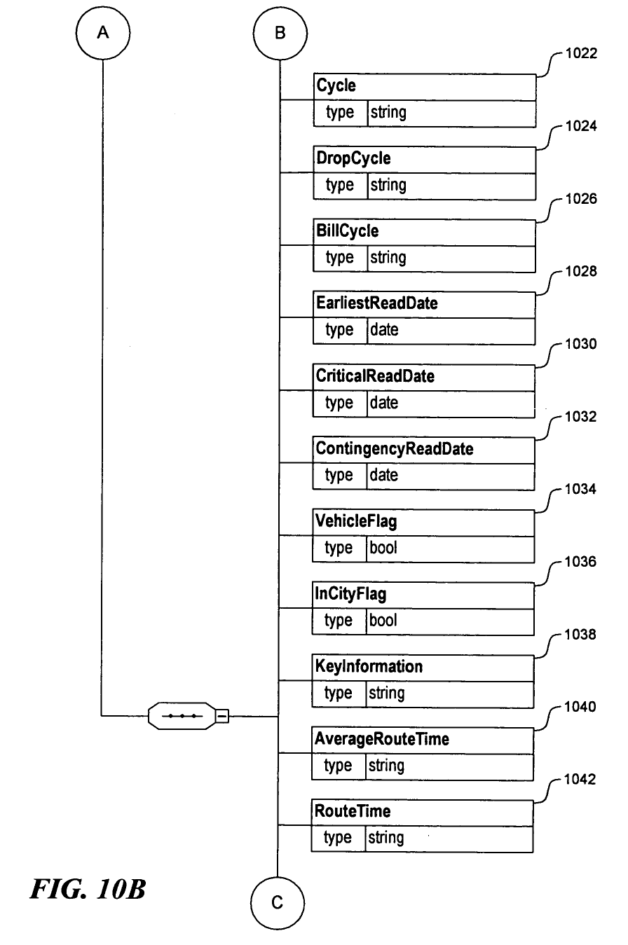

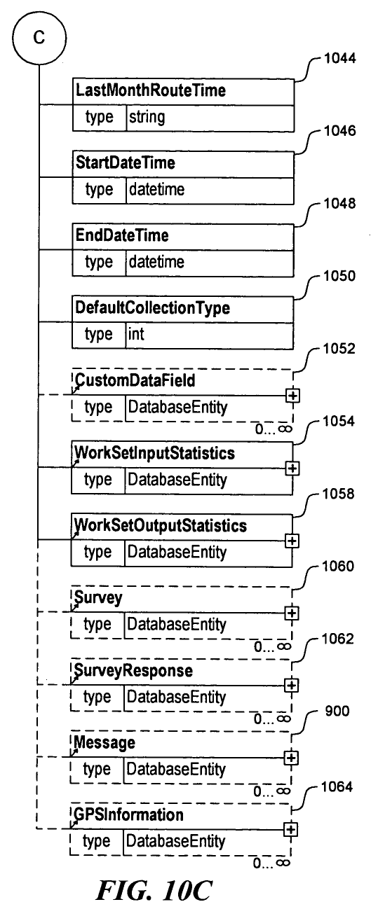

Both the import XML structure (FIG. 5) and the export XML structure (FIG. 6) may contain one or many WorkSet elements. Conceptually, a WorkSet element can be thought of as a container of one or more WorkSet elements, as described in more detail in FIGS. 10A-10C. In some embodiments, a work set is a collection of work (e.g., meter reading work or field service work) to be performed. The Work element is detailed in FIGS. 11A-11C.

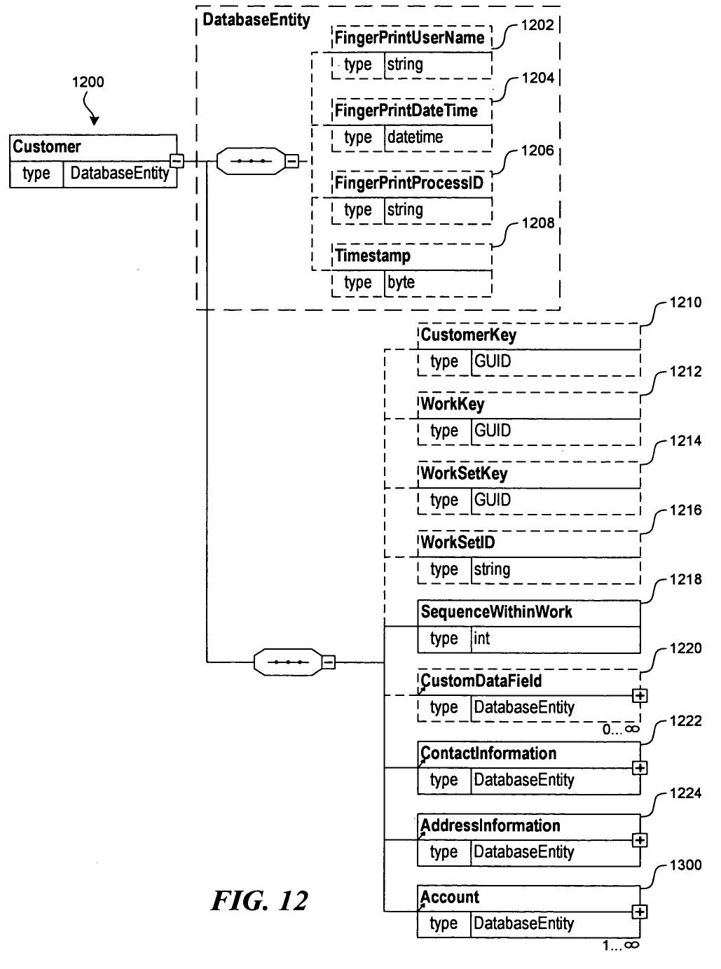

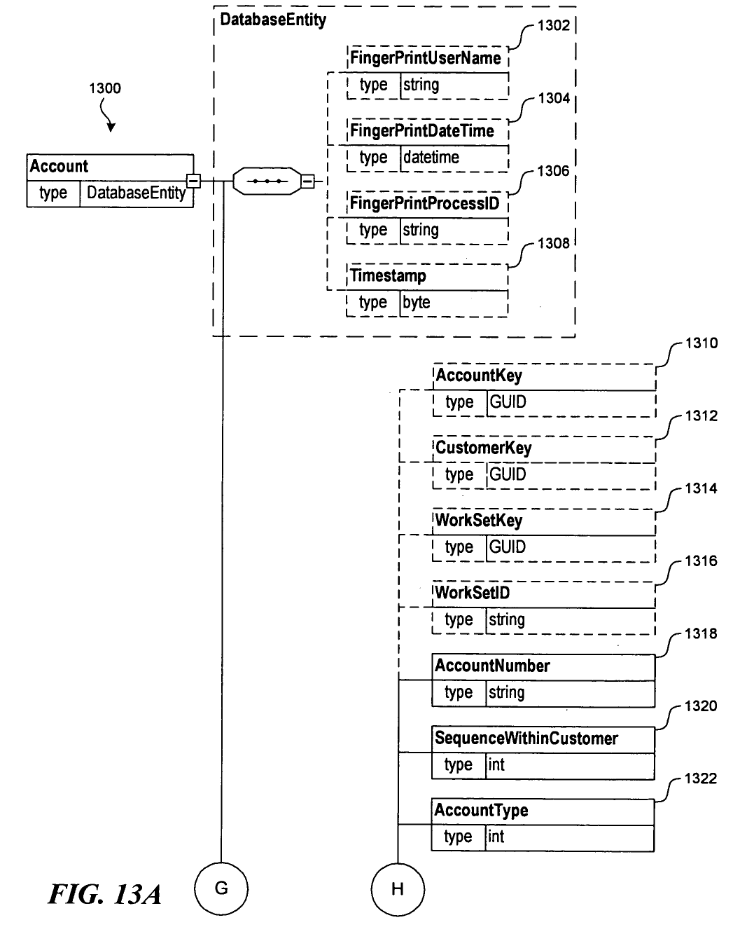

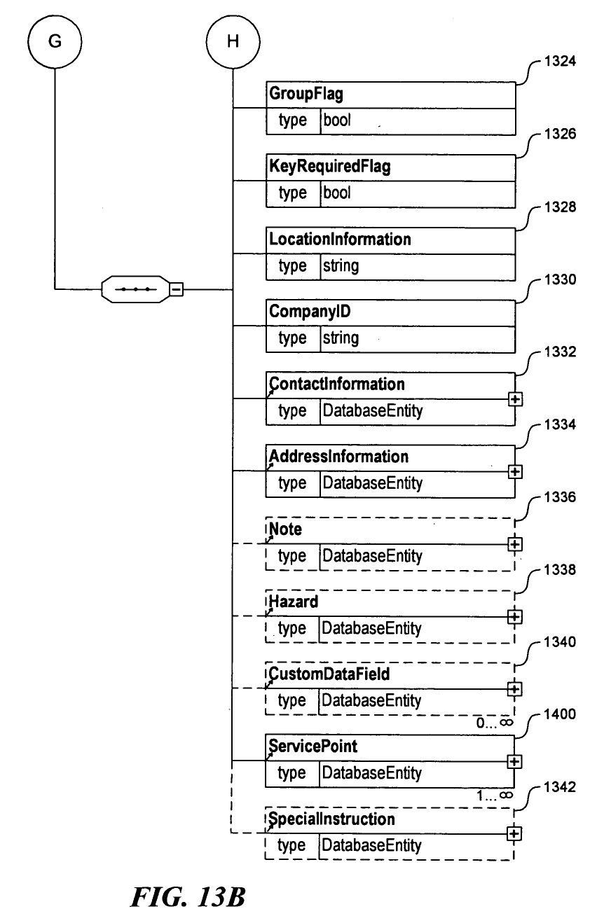

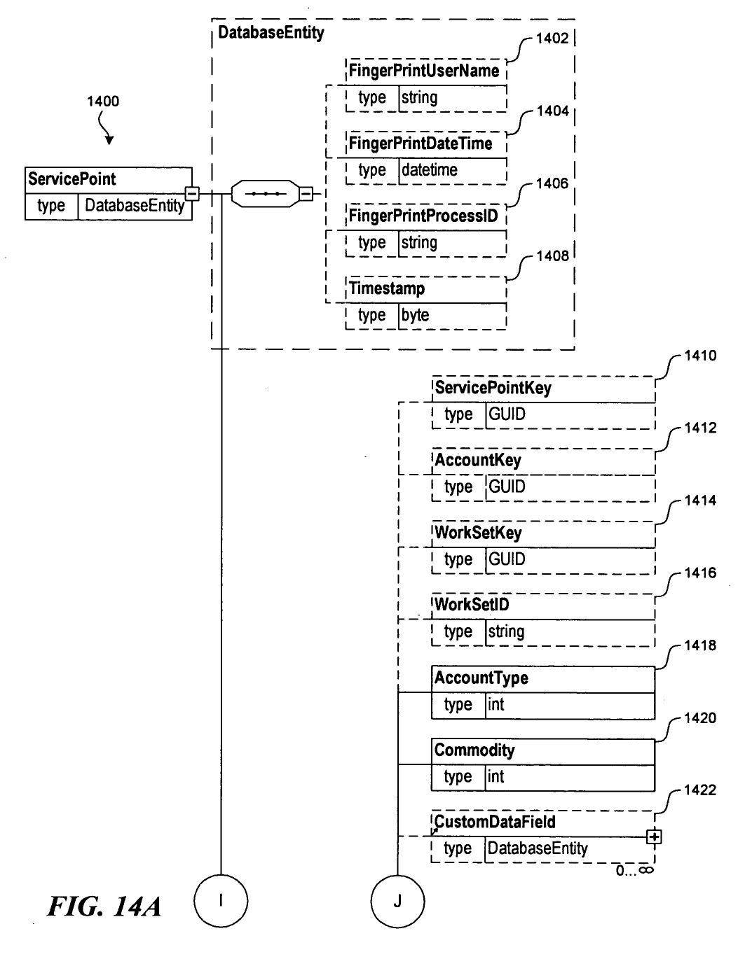

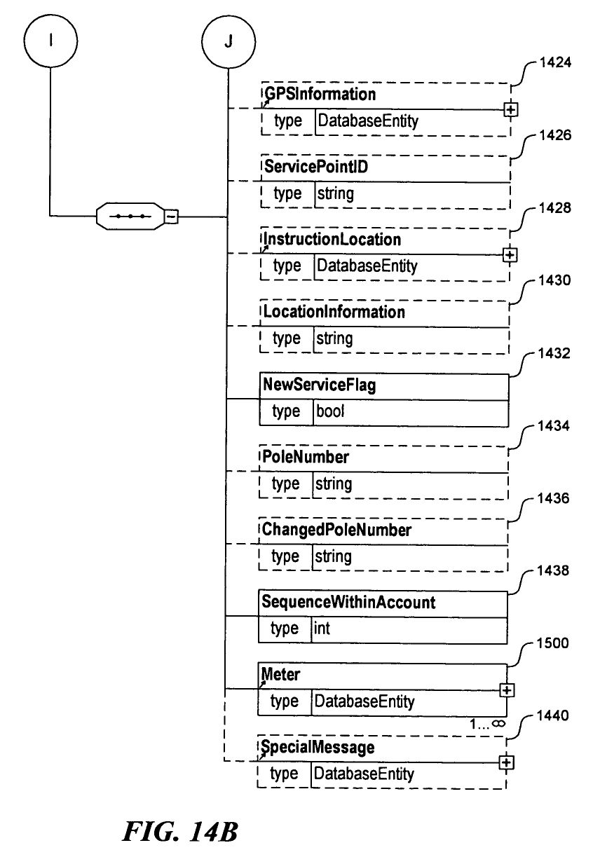

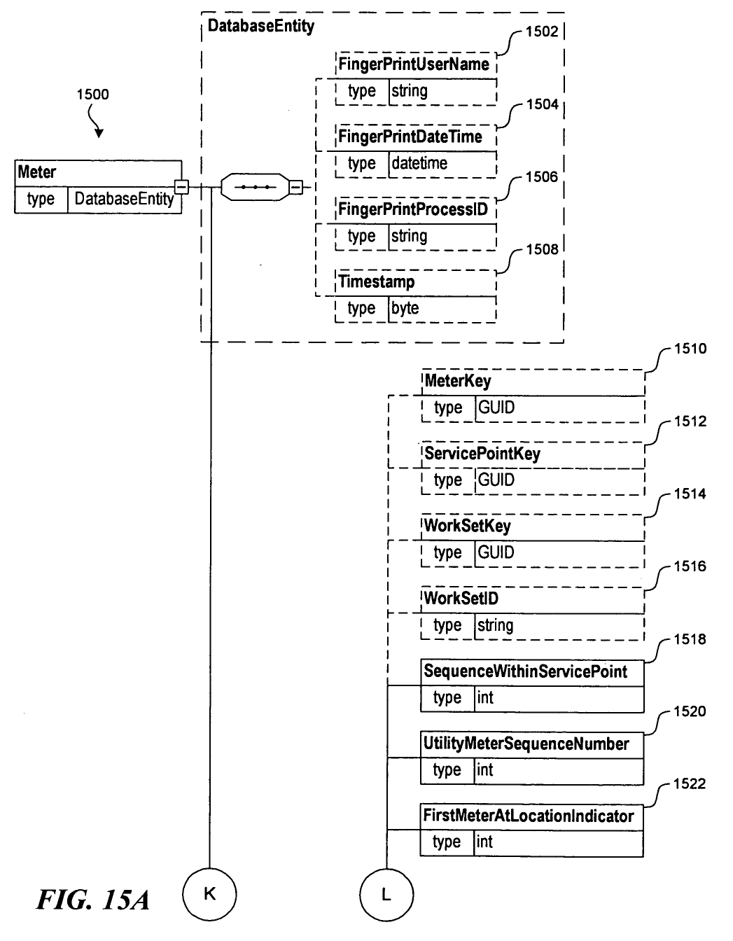

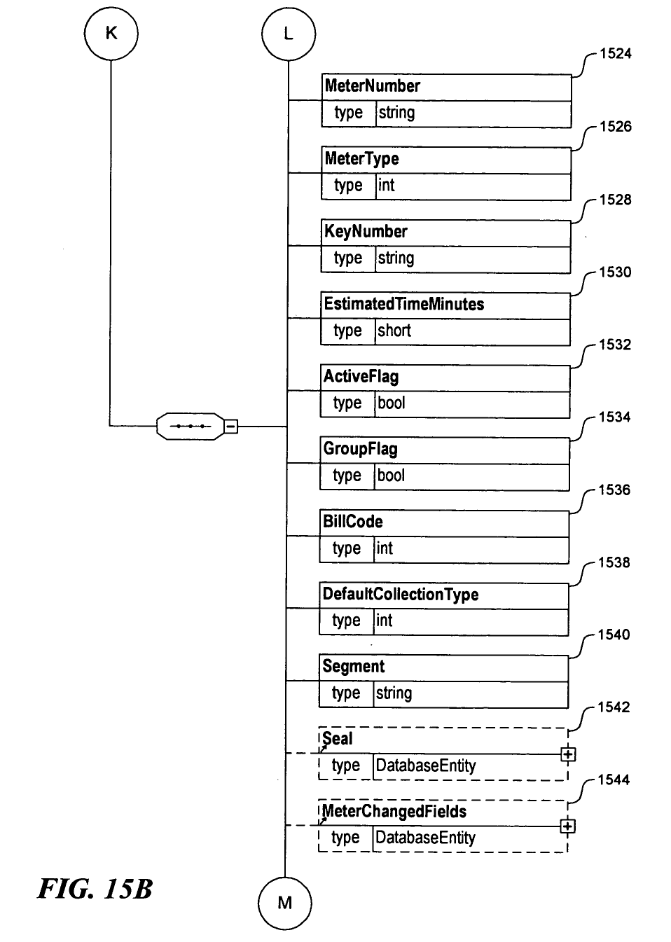

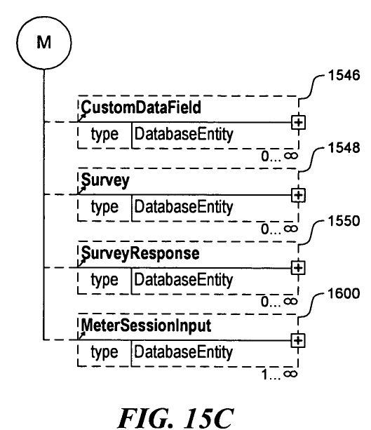

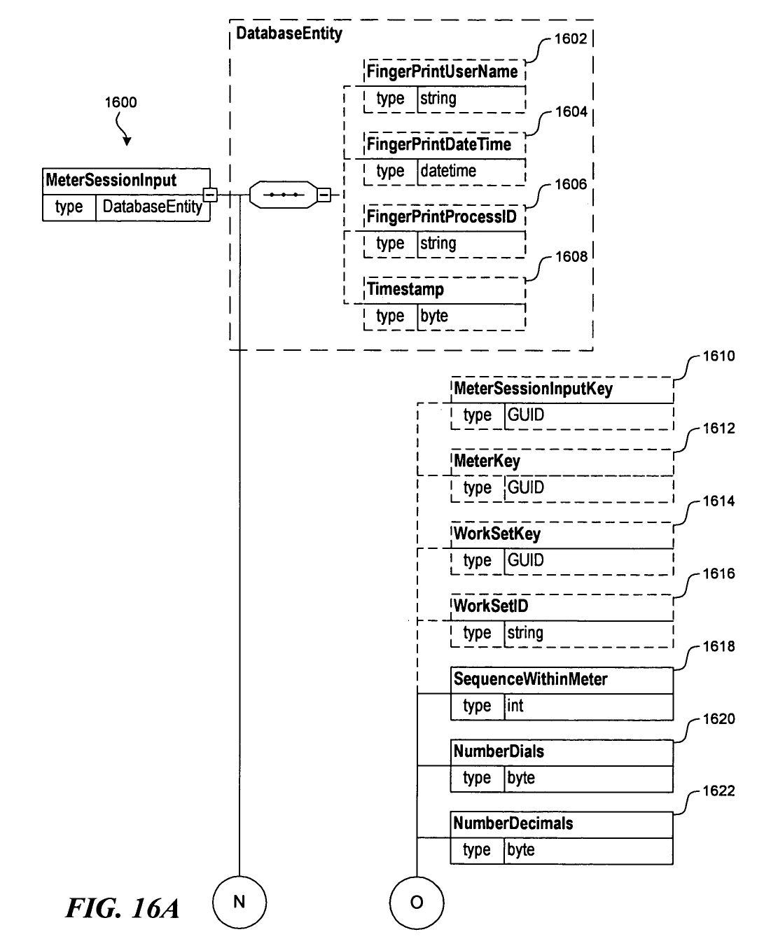

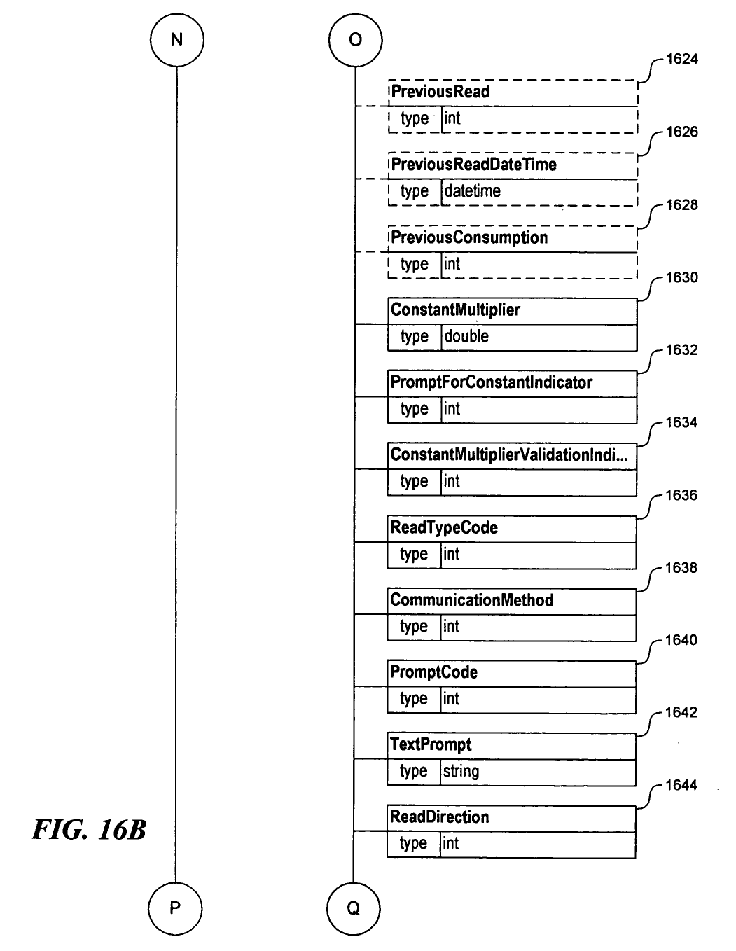

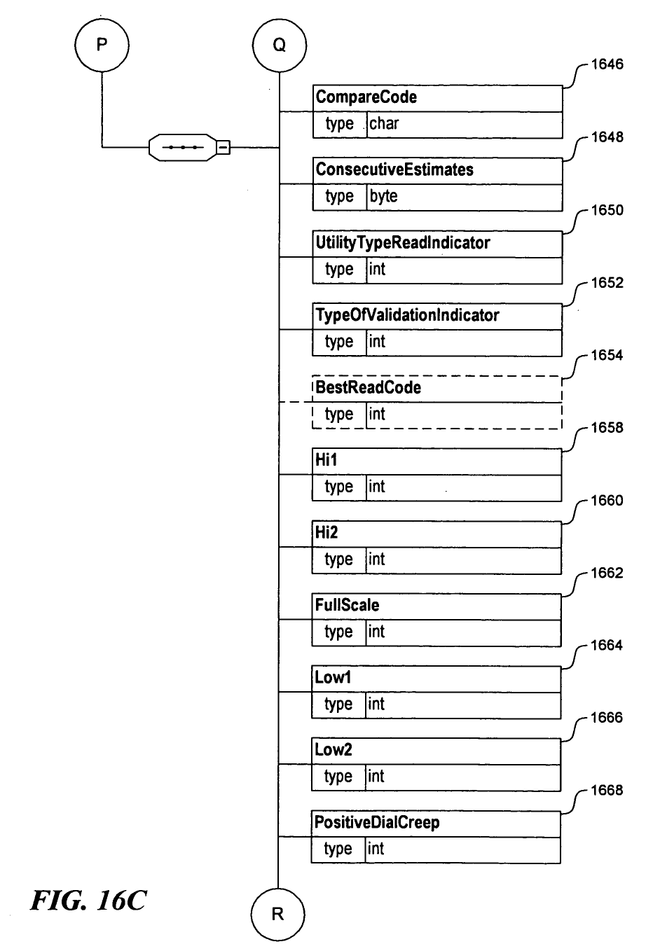

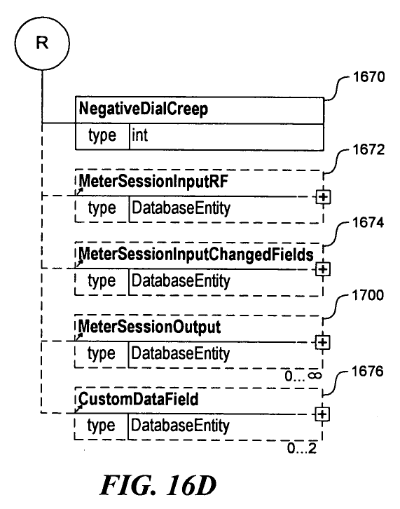

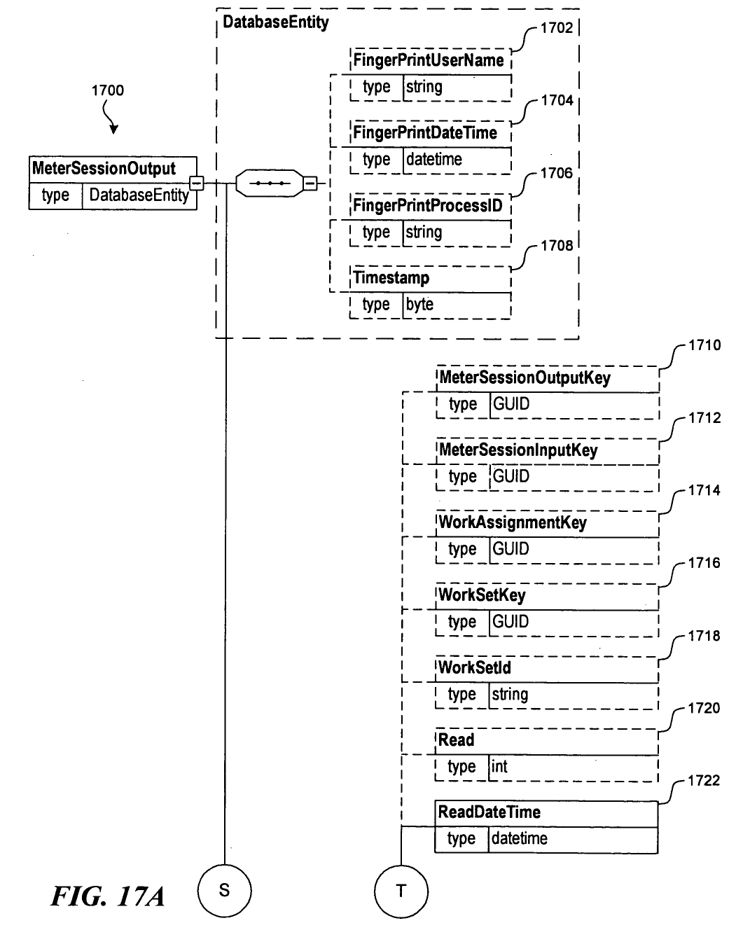

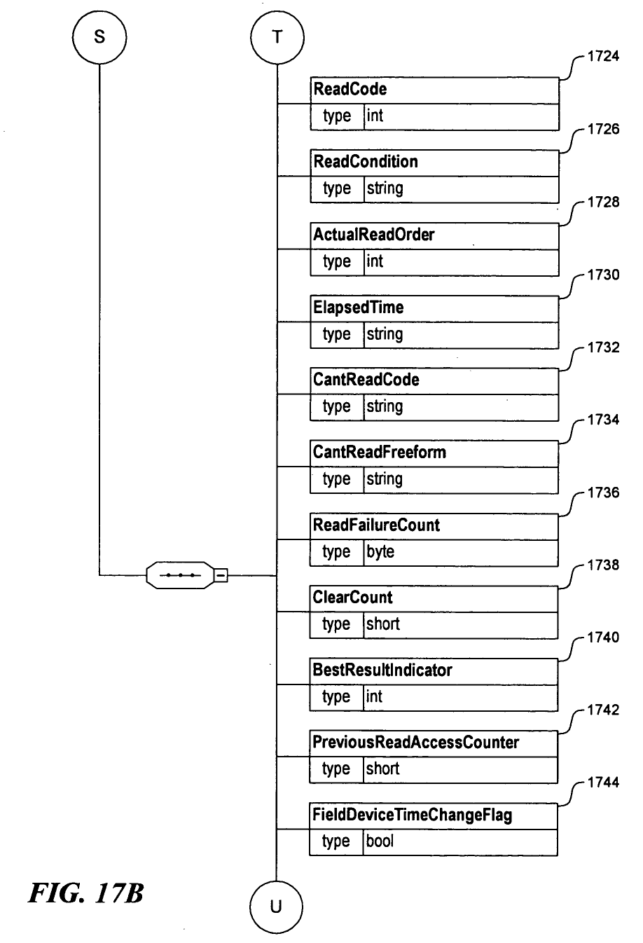

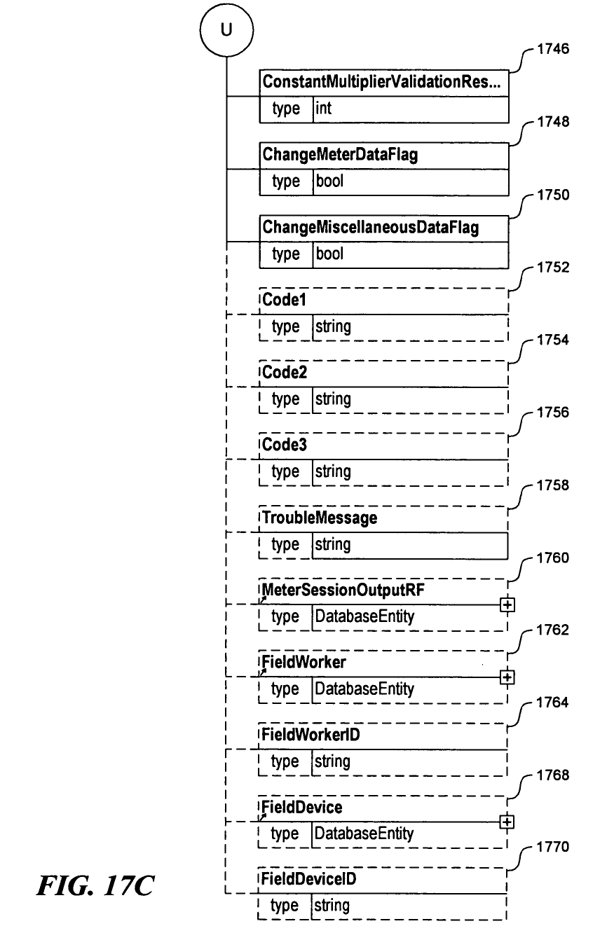

Referring again to FIGS. 10A-10C, the WorkSet element 1000 may contain a deep hierarchy of XML data. FIGS. 10A-10C show an example of a first level of a work set hierarchy. In general, a work set element defines a collection of work. For example, a work set may be a generic collection of work or it may be a meter reading route. For example, if a work set is a meter reading route, it may contain a route element that carries the additional information required for a route. It may also include the Work element (FIGS. 11A-11C), and a remainder of the hierarchy stemming from the Work element in the illustrated embodiment, including a Customer element (FIG. 12), an Account element (FIGS. 13A-13B), a ServicePoint element (FIGS. 14A-14B), a Meter element (FIGS. 15A-15C), a MeterSessionInput element (FIGS. 16A-16D), and a MeterSessionOutput element (FIGS. 17A-17C).

In the illustrated embodiment, various nodes/elements of the schema may have optional database entity elements. For example, the Messages element of FIG. 9 shows fingerprinting information, a time stamp, and a key, all shown in a boxed-off area, as part of its database entity elements. Because the Messages element maps directly to a database entity, this information may not be included as part of import or export XML data but may nonetheless be included in the schema diagram. A corresponding message database table may be created from the schema diagram, and data imported from the XML may map directly into the database table. The WorkSet element (FIGS. 10A-10C), the Work element (FIGS. 11A-11C), the Customer element (FIG. 12), the Account element (FIGS. 13A-13B), the ServicePoint element (FIGS. 14A-14B), the Meter element (FIGS. 15A-15C), the MeterSessionInput element (FIGS. 16A-16D), and the MeterSessionOutput element (FIGS. 17A-17C) may have similar database entity elements, shown in the illustrated embodiment.

The following description provides additional details regarding the nodes/elements of FIGS. 7-17C.

Referring to FIG. 7, the Codes node 700 may have one or more elements. Information structured in accordance with these elements may be used to provide codes to the supporting system or, in some cases, the utility system. In one example, the Codes node 700 includes a CantReadCodes element 702, an InstructionLocationCodes element 704, a TroubleCommentCodes element 706, a HazardCodes element 708, a SpecialInstructionCodes element 710, a SurveyCodes element 712, a SealColorCodes element 714, a SealReplacementReasonCodes element 716, a ForceCompleteReasonCodes element 718, a MeterTypeCodes element 720, a ReadTypeCodes element 722, a ReadTypeInformation element 724, and a ReadTypeReferences element 726.

Referring to FIG. 8, the Messages node 800 may include a Message element/node 900, which is described in more detail with respect to FIG. 9, and which may have one or more of its own elements. Information structured in accordance with these elements may be used to send a message to the supporting system or, in some cases, the utility system.

Referring to FIG. 9, the Message element/node 900 in the illustrated example includes a selection of database entity elements relating to the message (e.g., a FingerPrintUserName element 902, a FingerPrintDateTime element 904, a FingerPrintProcessID element 906, and a TimeStamp element 908). The Message element/node 900 in the illustrated example also includes a selection of primary and foreign database keys (e.g., a MessageKey element 910 (primary key), a WorkSetKey element 912 (foreign key), and a WorkAssignmentKey element 924 (foreign key)).

A MessageType element 914 indicates the type of the message. Sample values for the MessageType element 914 may include a global message, a route message, an assignment message, a cycle message, a cycle/hierarchy message, a hierarchy message, etc. A MessageValue element 916 provides a text message with an associated value for the message. A MessageChangedFlag element 918 indicates if the message has been changed since the time it was initially sent. Sample values for the MessageChangedFlag element 918 include true or false values indicating whether the message has been changed. A FilteringInformation element 920 contains utility filtering information. A Cycle element 922 denotes an associated cycle for the message (assuming that the message is a cycle message or a cycle/hierarchy message).

Referring to FIGS. 10A-10C, the WorkSet node 1000 may have one or more elements. Information structured in accordance with these elements may be used to send work sets of information between the supporting system and the utility system. For example, a work set may consist of a collection of meter routes assigned to the supporting the supporting system. More generally, the supporting system acts on work set objects when performing work. The WorkSet element/node 1000 in the illustrated example includes a selection of database entity elements relating to the work set (e.g., a FingerPrintUserName element 1002, a FingerPrintDateTime element 1004, a FingerPrintProcessID element 1006, and a TimeStamp element 1008). The WorkSet element/node 1000 in the illustrated example also includes a selection of primary and foreign database keys (e.g., a WorkSetKey element 1010 (primary key)).

A WorkSetID element 1012 relates to a visual identifier of the work set (e.g., for display on a user interface associated with the utility system or the supporting system). A WorkSetType element 1014 indicates the type of work set being communicated. In some embodiments, this value may help drive user interface functionality. Sample values for the WorkSetType element 1014 include a generic work set, a new service route, a pool route, a custom created route, a temporary route, a mainframe route, a contingency route, etc.

A ScheduledReadDate element 1016 relates to the date on which the utility system anticipates the work set will be read by the supporting system. A FilteringInformation element 1018 is used to divide the data of the work set based on assigned rules. The Work element 1100 is a generalization of all the functions the supporting system is intended to support. The Work element 1100 is described in more detail with respect to FIGS. 11A-11C. A WorkSetState element 1020 relates to the state of the work's work set. A CycleMessage element 1022 relates to the cycle identified for a particular route. In some embodiments, this information may be used to group routes on a route screen associated with the supporting system. A DropCycle element 1024 relates to a drop cycle for the work set. A BillCycle element 1026 relates to a bill cycle for the work set. An EarliestReadDate element 1028 relates to a date on which the supporting system should begin reading the work set. A CriticalReadDate element 1030 relates to a date on which the results from the work set should be sent back in an export file from the supporting system to the utility system. A ContingencyReadDate element 1032 relates to a date on which incomplete work associated with the work set (e.g., skipped reads, cant reads, and processed reads, etc.) should be contingency routed to an alternate supporting system (e.g., if the primary supporting system has not completed the work).

If the work set is a meter reading route, a VehicleFlag element 1034 indicates whether the route is a vehicle or walking route. An InCityFlag element 1036 indicates whether or not the route is in the city. A KeyInformation element 1038 relates to KeyInformation for the route. An AverageRouteTime element 1040 relates to the average time it takes to complete the route at issue. In some embodiments, if the utility system does not provide this information, the supporting system may calculate it. A RouteTime element 1042 relates to the actual time for completing the route. A LastMonthRouteTime element 1044 relates the time it took to complete the route in the previous month. In some embodiments, if the utility system does not provide this information, the supporting system may calculate it.

A StartDateTime element 1046 relates to the earliest start date/time for the work set (e.g., the start date/time for the most urgent assignment in the work set). An EndDateTime element 1048 relates to the end date/time start date/time for the work set (e.g., the start date/time for the least urgent assignment in the work set). A DefaultCollectionType element 1050 indicates the default collection type for the work being performed. Information associated with this element helps direct the work to the most suitable collection system and collection technology. Examples of valid values for the DefaultCollectionType element 1050 include handheld, mobile collector, CCU, etc. A CustomDataField element 1052 relates to miscellaneous information provided by the customer. In some embodiments, customers may use such custom data fields to provide any data that they choose.

A WorkSetInputStatistics element 1054 relates to statistics based on the work set information received by supporting system. A WorkSetOutputStatistics element 1058 relates to statistics based on the work set information sent to the utility system. A Survey element 1060 relates to survey and meter audit functionality of any previous supporting systems. In some embodiments, a utility can define as many surveys as it wants. A SurveyResponse element 1062 provides responses to survey questions from the Survey element 1060. It may also contain a freeform response with additional information related to the survey.

In the illustrated embodiment, the Message element/node 900 occurs at the work set element level, and not only the import/export level. FIG. 9 provides additional detail about the Message element 900. A GPSInformation element 1064 provides GPS coordinates/locations of associated data. The GPSInformation element 1064 may contain both original values and changed values.

Referring to FIGS. 11A-11C, the Work node 1100 may have one or more elements. Information structured in accordance with these elements may be used to send specific requests for work (e.g., work orders) to the supporting system and to send specific results of work (e.g., work results) to the utility system. In general, work or work order information corresponds to the functions that the supporting system is intended to support. The Work element/node 1100 in the illustrated example includes a selection of database entity elements relating to the work or work order (e.g., a FingerPrintUserName element 1102, a FingerPrintDateTime element 1104, a FingerPrintProcessID element 1106, and a TimeStamp element 1108). The Work element/node 1100 in the illustrated example also includes a selection of primary and foreign database keys (e.g., a WorkKey element 1110 (primary key) and a WorkSetKey element 1112 (foreign key)).

An ExternalID element 1114 relates to external identifier for the work. For example, when the supporting system performs work in conjunction with an external supporting service (e.g., Service-Link), it may be used to contain the work ID from that external supporting service. In this way, results from the work and statuses for the work may be mapped back to the external supporting service. A Segment element 1116 identifies a range of work or work orders within the parent work set that are associated with the work. A SequenceNumber element 1118 identifies the current sequence of the work or work order in the work set. A ScheduleWorkDateTime element 1120 relates to the date and time that the work is scheduled to be completed. In some embodiments the ScheduleWorkDateTime element may be an optional field that is used to schedule field service work orders, but can also be used to schedule meter reading work. A ChangedSequenceNumber element 1122 identifies the current sequence of the work or work order (relative to the work set) if the sequence has changed. A WorkSetID element 1124 relates to a visual identifier of the work set (e.g., for display on a user interface associated with the utility system or the supporting system). If the work set to which the work belongs has changed, then a ChangedWorkSetID element 1126 may be used to indicate this new work set ID. A LastWorkSetID element 1128 maintains the ID of the to which the work or work order belonged when it was imported from the utility system. It may also relate to the ID of the last permanent work set to which the work or work order belonged. A WorkTypeID element 1130 indicates the type of the work of the work order. Valid values for the WorkTypeID element 1130 may include meter read, connect, disconnect, meter reprogram, meter service, meter replacement, safety inspection, special read, survey, telemetry control, etc.

A DefaultCollectionType element 1132 indicates the default collection type for the work. The DefaultCollectionType element 1132 helps direct the work to the right collection system and/or collection technology. Sample values for the DefaultCollectionType element 1132 include field device, handheld, mobile collector, CCU, etc. A Source element 1134 indicates the source (origin) of the work or work order. Sample values for the Source element 1134 include CIS system, Service-Link, MRFS (meter reading field service) persistence store, MRFS application server, MRFS field device, etc.

A FirstUtilityMeterSequenceNumber element 1136 identifies the utility sequence number of the first meter session for the work or work order. During download, the utility meter sequence of the first meter session may be set according to this number. Utility meter sequences for additional meter sessions for the work or work order may be calculated. A PermanentlyReroutedFlag element 1138 indicates whether the work or work order has been permanently rerouted to the parent work set. A CopiedFlag element 1140 indicates whether the work or work order has been copied to another work set. A ChangeIndicator element 1142 indicates that the work or work order has changed, since initiated. It also identifies the subsystem that was responsible for changing the work order.

A GMTOffset element 1144 provides information on the GMTOffset for the work. A DSTFlag element 1146 provides information on daylight savings time. A CustomDataField element 1148 relates to miscellaneous information provided by the customer. In some embodiments, customers may use such custom data fields to provide any data that they choose. A GPSInformation element 1150 relates to GPS coordinates/locations, such as the GPS coordinates for meters. A Customer element/node 1200 relates to various types of information for a specific customer associated with the work or work order. The Customer element/node 1200 is described in more detail with respect to FIG. 12. A FieldServiceField element 1152 provides field service order information associated with the work or work order.

Referring to FIG. 12, the Customer node/element 1200 may have one or more elements. Information structured in accordance with these elements may be used to relay information for specific customers between the supporting system and the utility system. The Customer element/node 1200 in the illustrated example includes a selection of database entity elements relating to the customer (e.g., a FingerPrintUserName element 1202, a FingerPrintDateTime element 1204, a FingerPrintProcessID element 1206, and a TimeStamp element 1208). The Customer element/node 1200 in the illustrated example also includes a selection of primary and foreign database keys (e.g., a CustomerKey element 1210 (primary key), a WorkKey element 1212, (foreign key), and a WorkSetKey element (foreign key)).

A WorkSetID element 1216 relates to a visual identifier of the work set (e.g., for display on a user interface associated with the utility system or the supporting system). A SequenceWithinWork element 1218 relates to the relative sequence of the customer within the parent work hierarchy. A CustomDataField element 1220 relates to miscellaneous information provided by the customer. In some embodiments, customers may use such custom data fields to provide any data that they choose. A ContactInformation element 1222 relates to contact information for the customer. An AddressInformation element 1224 relates to address information for the customer. An Account element 1300 is associated with an account for the customer. The Account element/node 1300 is described in more detail with respect to FIGS. 13A-13B.

Referring to FIGS. 13A-13B, the Account element/node 1300 may have one or more elements. Information structured in accordance with these elements may be used to relay information for specific accounts between the supporting system and the utility system. The Account element/node 1300 in the illustrated example includes a selection of database entity elements relating to the account (e.g., a FingerPrintUserName element 1302, a FingerPrintDateTime element 1304, a FingerPrintProcessID element 1306, and a TimeStamp element 1308). The Account element/node 1300 in the illustrated example also includes a selection of primary and foreign database keys (e.g., an AccountKey element 1310 (primary key), a CustomerKey element 1312 (foreign key) and a WorkSetKey element 1314 (foreign key)).

A WorkSetID element 1316 relates to a visual identifier of the work set (e.g., for display on a user interface associated with the utility system or the supporting system). An AccountNumber element 1318 relates to a number that is generated, maintained, and used to identify each customer on the utility's customer information system (CIS). If the customer has multiple accounts, a SequenceWithinCustomer element 1320 relates to the relative sequence number of the account. An AccountType element 1322 relates to the type of account for the account data. Sample valid values for the AccountType element 1322 include residential, commercial, industrial, etc. A GroupFlag element 1324 provides an indication of whether or not a field worker should collect readings from all meters for the account.

A KeyRequiredFlag element 1326 provides an indication of whether a physical key is needed to access any service points associated with the account. A LocationInformation element 1328 relates to generic location information for the account, which the utility may provide. For example, location information may be a grid number, a map number, a town, a zip code, an area code, an extension of the address from the work order, etc. A CompanyID element 1330 relates to a company name or other identifier, which can then be displayed to the field worker while he or she is out in the field performing work associated with the account. A ContactInformation element 1332 relates to contact information for the account, which may or may not be the same as contact information for the customer. Accordingly, this field may be optional. Likewise, an AddressInformation element 1334 relates to address information for the account.

A NoteElement 1336 relates to a note that may be displayed on a user interface, such as on a screen of the supporting system or on the screen of the field device. A Hazard element 1338 relates to information that warns a field worker of a problem. In some embodiments a note may be distinguished from a hazard based on audible tone presented on the field device. For example, a note may cause the field device to beep once while a may hazard cause the field device to beep three times. A CustomDataField element 1340 relates to miscellaneous information provided by the customer. In some embodiments, customers may use such custom data fields to provide any data that they choose. A ServicePoint element/node 1400 is described more with respect to FIGS. 14A-14B. A SpecialInstruction element 1342 provides a field for special instructions to users of the supporting system or of the utility system.

Referring to FIGS. 14A-14B, the ServicePoint element/node 1400 may have one or more elements. Information structured in accordance with these elements may be used to relay information for specific service points between the supporting system and the utility system. The ServicePoint element/node 1400 in the illustrated example includes a selection of database entity elements relating to the service point (e.g., a FingerPrintUserName element 1402, a FingerPrintDateTime element 1404, a FingerPrintProcessID element 1406, and a TimeStamp element 1408). The ServicePoint element/node 1400 in the illustrated example also includes a selection of primary and foreign database keys (e.g., a ServicePointKeyData element 1410 (primary key), an AccountKey element 1412 (foreign key), a WorkSetKey element 1414 (foreign key)).

A WorkSetID element 1416 relates to a visual identifier of the work set (e.g., for display on a user interface associated with the utility system or the supporting system). An AccountType element 1418 indicates the type of account associated with the service point. Sample values for the AccountType element 1418 include residential, commercial, industrial, etc. A Commodity element 1420 relates to the commodity measured at the service point. Sample values for the Commodity element 1420 include electric, gas, water, etc. A CustomDataField element 1422 relates to miscellaneous information provided by the customer. In some embodiments, customers may use such custom data fields to provide any data that they choose.

A GPSInformationData element 1422 provides GPS coordinates/locations associated with the service point. The GPSInformation element 1424 may contain both original values and changed values (i.e., changed by the supporting system). A ServicePointID element 1426 relates to a system-generated external ID for the service point, which can then be mapped to other supporting services (e.g., Service-Link). An InstructionLocation element 1428 provides information on the location of instructions for the field worker. A LocationInformation element 1430 relates to generic location information for the service point, which may be provided by the utility. This may be a grid number, a map number, a town, a zip code, an area code, an extension of the address, or other information from the work or work order. In some embodiments, the LocationInformation element 1430 may be updated by the field worker on the field device or from the utility's CIS.

A NewServiceFlag element 1432 provides an indication if the service point is associated with a new service. A PoleNumber element 1434 relates to a number associated with a utility pole associated with the service point. A ChangedPoleNumber element 1436 provides information on pole numbers if this information has recently changed. If the customer account has several service points, a SequenceWithinAccount element 1438 relates to the relative sequence of the service point. A Meter element/node 1500 relates to a particular meter at the service point and is described in more detail with respect to FIGS. 15A-15C. A SpecialMessage element 1440 relates to a special message that may be provided in association with the service point data.

Referring to FIGS. 15A-15C, the Meter node 1500 may have one or more elements. Information structured in accordance with these elements may be used to relay information for specific meters between the supporting system and the utility system. The Meter element/node 1500 in the illustrated example includes a selection of database entity elements relating to the meter (e.g., a FingerPrintUserName element 1502, a FingerPrintDateTime element 1504, a FingerPrintProcessID element 1506, and a TimeStamp element 1508). The Meter element/node 1500 in the illustrated example also includes a selection of primary and foreign database keys (e.g., a MeterKey element 1510 (primary key), a ServicePointKey element 1512 (foreign key), a WorkSetKey element 1514 (foreign key)).

A WorkSetID element 1516 relates to a visual identifier of the work set (e.g., for display on a user interface associated with the utility system or the supporting system). If a service point has multiple meters, a SequenceWithinServicePoint element 1518 relates to a relative sequence of the meter. If the utility has its own sequence number for each meter, a UtilityMeterSequenceNumber element 1520 relates to this relative sequence number. In some embodiments, field workers can perform searches by meter sequence number. A FirstMeterAtLocationlndicator element 1522 indicates if the meter is a location meter (the first meter of a meter bank) or an extra meter (any non-first meter of a meter bank). This information may then be used to determine how many meter stops are on a meter reading route.

A MeterNumber element 1524 relates to the number used to visually identify the meter (e.g., found on the meter's outer case). In some embodiments, the field worker may use this information to perform a search. The meter number may not necessarily be unique within the route, but may be used in case of an internal meter number mismatch error. A MeterType element 1526 relates to the service type of the meter. Sample values for the MeterType element 1526 include electric, gas, water, irrigation, steam/sewer, uncorrected gas, electric (multichannel recorder), electric (single channel recorder), electric (TOU meter with load profile), electric (TOU only), etc.

A KeyNumber element 1528 relates to the number of keys used to open locks associated with the meter if a key is needed. An EstimatedTimeMinutes element 1530 relates to the estimated time (in minutes) needed to proceed from the previous meter read to the current meter. An ActiveFlag element 1532 relates to an indication of the meter's current activity status. On the field device this may coincide with whether or not the meter is associated with a current billable customer. In some embodiments, the active flag information may be used to detect validation failures. A GroupFlag element 1534 indicates whether or not readings for a meter should be grouped together. For example, when reading an electronic TOU register with a scrolling display, the utility may want to ensure that the field worker obtains all the readings before moving on to the next meter. A BillCode element 1536 relates to an indication of the billing rate of a meter. It may be used for information purposes and may be set to any value. A bill code may be used to search from the field service but cannot be changed. Sample values for the BillCode 1536 element include residential, commercial, industrial, etc.

A DefaultCollectionType element 1538 indicates the dated default collection type for the meter. This information may help direct the work to the right collection system/collection technology. Sample valid values for the DefaultCollectionType element 1538 include handheld, field device, mobile collector, CCU, etc. A Segment element 1540 relates to a unique identifier of a geographic grouping of work within a route. The supporting system may use this information to break up a large number of work orders into manageable segments. At the field device, the field worker may use the segment information to perform a status check as each segment is completed.

A Seal element 1524 relates to a seal at the meter. A MeterChangedField element 1544 relates to whether the meter has been changed to a new meter. A CustomDataField element 1546 relates to miscellaneous information provided by the customer. In some embodiments, customers may use such custom data fields to provide any data that they choose. A Survey element 1548 relates to a survey, which encompasses the survey and audit functionality of previous systems. A utility can theoretically define as many surveys as it wants. A SurveyResponse element 1550 provides the responses to survey questions. It may also contain a freeform response with additional information related to the survey. A MeterSessionInput element 1600 defines the operations to be performed during a session with the indicated meter. The MeterSessionInput element/node 1600 is described in more detail with respect to FIGS. 16A-16D.

Referring to FIGS. 16A-16D, the MeterSessionInput element/node 1600 of FIGS. 16A-16D may have one or more elements. Information structured in accordance with these elements may be used to relay information for specific meter sessions between the supporting system and the utility system. In some embodiments, a meter session may be dependent on its communications method (e.g., automatic read, optical read, manual read, etc.) For example, for a TOU meter, there could be three meter sessions (e.g., one to read the device optically, one to the read the digital display manually, and one to read the mechanical dials). The supporting system may create entries in a meter session input table during import processing or during field device communications merge processing. Entries are deleted during route deletion and may be modified during a field device communications merge or by an office employee.

The MeterSessionInput element/node 1600 in the illustrated example includes a selection of database entity elements relating to the meter session (e.g., a FingerPrintUserName element 1602, a FingerPrintDateTime element 1604, a FingerPrintProcessID element 1606, and a TimeStamp element 1608). The ServicePoint element/node 1600 in the illustrated example also includes a selection of primary and foreign database keys (e.g., a MeterSessionInputKey element 1610 (primary key), a MeterKey element 1612 (foreign key), a WorkSetKey element 1614 (foreign key)).

A WorkSetID element 1616 relates to a visual identifier of the work set (e.g., for display on a user interface associated with the utility system or the supporting system). Where a meter has multiple meter sessions, a SequenceWithinMeter element 1618 relates to the relative sequence of the meter session input. A NumberDials element 1620 relates to the number of dials in a meter session reading. For a manual reading, the field device uses this information to determine how many digits to prompt the field worker to enter. In a TOU probing process where there is an internal/external meter number mismatch and a new service is collected as a result of the mismatch, the number of dials is set to greater than zero and the field device prompts for a mechanical dial entry. A NumberDecimals element 1622 relates to the number of decimal positions to the right to display in the prompt for the read. In the case of an optical read, the NumberDecimals element 1622 relates to the number of positions to the right of the embedded decimal in the output generated by the read. A PreviousRead element 1624 relates to the last date the meter was read according to the meter itself. In some embodiments, field workers may view this value at the field device. A PreviousReadDateTime element 1626 relates to the last date the meter was read. This information may be used to determine whether there has been a seasonal change in conjunction with a read item list to collect previous season data. It may also be used to determine if a reading passes high/low limits. A PreviousConsumptionData element 1628 relates to a consumption data value passed in the utility input file. In some embodiments, this information may be viewed at the field device. The previous consumption information can also be displayed on custom reports or database queries.

A ConstantMultiplier element 1630 relates to the multiplier for the meter or for a specific read if the meter is being read manually. The field device may use this field to calculate the daily average consumption usage. A PromptForConstantIndicatorField element 1632 relates to whether and when a the field device should prompt a meter for a constant multiplier. Sample values for the PromptForConstantIndicatorField element 1632 include do not prompt for constant/multiplier, prompt for constant/multiplier for before meter, prompt for constant/multiplier after meter. If the meter session involves manual reads, a ConstantMultiplierValidationIndicator element 1634 relates to whether the field worker should be prompted to validate the multiplier (billing constant) or the KH meter constant. For example, it may indicate whether the field worker should be prompted to validate the constant multiplier from the meter session input. If the meter session involves optical reads the ConstantMultiplierValidationIndicator element 1634 indicates whether the KE or KH constant read from the meter should be validated against the constant multiplier from the meter session input.

A ReadTypeCode element 1636 relates to a code that assists the field worker in identifying the kind of reading to retrieve from a particular meter during a meter session. A CommunicationMethod element 1638 specifies the communication method used to perform a read during the meter session. Sample valid values include manual, optical, inductive, RF/OMR, RF/MAMR, etc. A PromptCode element 1640 relates to a prompt that the field device may display. Sample values include prompting the field worker for a reading, displaying the account/reading but not prompting for a reading, indicating a must read that will display a warning if the field worker enters a skip code, indicating a force read that will prevent a reading from being skipped, prompting for a reading if the optical probe fails, etc. A TextPrompt element 1642 relates to specific text information used to describe the type of reading. In general, the text prompt field is used to display information for the field worker. The prompt may be displayed on the field device next to the reading to be entered. Any characters may be used but examples include KWH, KW, DMD, WATR, GAS, KBAR, PROB, etc.

A ReadDirection element 1644 relates to the direction in which reads associated with the session should be entered onto the field device. Sample values include left to right, right to left, etc. A CompareCode element 1646 relates to a value that allows two readings for the same meter to be compared. The compared information may then be used in reports and for TOU meter auditing. In the case where the meter was, at some point, not readable a ConsecutiveEstimates element 1648 relates to the number of consecutive times the utility system has estimated the readings for a specified meter. If a field worker enters a cant read on a meter that has exceeded a threshold value for this element, a must read warning may be displayed on the field device. A UtilityTypeReadIndicator element 1650 relates to an indication of the type of reading to be obtained. The utility may define this value and translate it to its corresponding supporting system-defined value. The field may be displayed on the field device's main meter display (e.g., kilowatt hour read, demand, water, etc.) The utility can send any desired value. Sample values include first reading on multiple dial water, second reading on multiple water, third reading on multiple dial water, accumulative demand, electric, gas single dial, front dial gas meter, back dial gas meter, reactive, date, pressure reading gas meter, reset demand, steam, TOU/IDR, single dial water meter, KVAR, mechanical dials reading for TOU, etc.

A TypeOfValidationIndicator element 1652 relates to the type of validation to be performed for the session. This value may support the function of high/low and full-scale validation. Sample valid values include no validation, high/low accumulative, high/low reset, full scale, full scale reset, daily average, etc. A BestReadCode element 1654 identifies the read code that has been posted for the best meter session output associated with the session. A Hi1 element 1658 relates to the first high level check for a reading difference allowed for the current billing period. This information may be used for high/low validations. A Hi2 element 1660 relates to the expected maximum reading difference allowed for the current billing period. This information may be used for high/low validations passed on the read item validation indicator. A FullScale element 1662 relates to the expected maximum reading difference allowed for the current billing period. This information may be used for high/low and full scale validations. A Low1 element 1664 relates to the first low level check for reading difference allowed for the current billing period. This information may be used for high/low validations. A Low2 element 1666 relates to the expected lowest reading difference allowed for the current billing period. This information may be used for high/low validations or the expected daily average consumption usage (as determined by a read item validation indicator).

A PositiveDialCreep element 1668 relates to an allowed meter dial creep amount for the meter. For inactive meters the usage allowed before the reading is flagged as having “usage on inactive meter.” On active meters if usage is less than this amount the reading is flagged as having “no usage on active meter.” The same implied decimal scheme is used here as the current reading, previous reading, and high/low values. A NegativeDialCreep element 1670 relates to negative creep for the meter. On active meters, if usage is this amount or less, then this amount, the reading is flagged as having no usage on active meter. A MeterSessionInputRF element 1672 relates to information required to obtain a RF reading the associated meter session input. A MeterSessionInputChangedField element 1674 relates to whether input for the meter session has changed. A MeterSessionOutput element 1700 relates to the output from a meter session input. The MeterSessionOutput element/node 1700 is described in more detail with respect to FIGS. 17A-17C. A CustomDataField element 1676 relates to miscellaneous information provided by the customer. In some embodiments, customers may use such custom data fields to provide any data that they choose.

Referring to FIGS. 17A-17C, the MeterSessionOutput node 1700 may have one or more elements. Information structured in accordance with these elements may be used to relay meter session output information (e.g., meter reading output) between the supporting system and the utility system. In some embodiments, there may be multiple meter session outputs for each meter session. The MeterSessionOuput element/node 1700 in the illustrated example includes a selection of database entity elements relating to the output (e.g., a FingerPrintUserName element 1702, a FingerPrintDateTime element 1704, a FingerPrintProcessID element 1706, and a TimeStamp element 1708). The MeterSessionOutput element/node 1700 in the illustrated example also includes a selection of primary and foreign database keys (e.g., a MeterSessionOutputKey element 1710 (primary key), a MeterSessionInputKey element 1712 (foreign key), a WorkAssignmentKey element 1714 (foreign key), and a WorkSetKey element 1716 (foreign key)).

A WorkSetID element 1718 relates to a visual identifier of the work set (e.g., for display on a user interface associated with the utility system or the supporting system). A Read element 1720 relates to processing of a reading. A ReadDateTime element 1722 relates to the date and time a read was taken. A ReadCode element 1724 relates to the type of reading entered. Sample values for a ReadCodeElement 1724 include skipped, regular, cant read, OMR read, manual read, customer read, field estimate, scanned remote read, manual remote read, optical read (e.g., TOU, IDR, optical demand meter, 10, etc.), pass by, MAMR read, IHP read, forced complete, etc. A ReadCondition element 1726 relates to the result of the validation of the reading or the force complete reason code. An ActualReadOrder element 1728 relates to the relative order in which the meter session output was produced within the session or within an assignment consisting of multiple sessions.

An ElapsedTimeElement 1730 relates to the amount of time it took to proceed from completion of the previous reading to completion of the current reading. A CantReadCode element 1732 relates to a utility-defined code indicating a valid reason for not reading a meter. A CantReadFreeform element 1734 relates to a freeform comment regarding a cant read of a meter. A ReadFailureCount element 1736 relates to the number of times the reading failed validation checks for the particular meter session. A ClearCountElement 1738 relates to the number of times a read was cleared. A BestResultIndicator 1740 relates to whether the meter session output is the best of possible multiple outputs based on criteria defined for a best result indicator. Sample valid values include not the best for the associated assignment, best for the associated assignment but not best for meter session input, best for the meter session input, etc. A PreviousReadAccessCounter element 1742 relates to the number of times the field worker looked at the previous read. A FieldDeviceTimeChangeFlag element 1744 provides an indication of whether a time change occurred in the field device during the processing of the meter session input associated with the meter session output. A ConstantMuliplierValidationResult element 1746 relates to the result of a comparison of the expected multiplier (billing constant) KE, or KH and the multiplier, KE or KH entered by the field worker or read from an optical device. Sample valid values for the ConstantMuliplierValidationResult element 1746 include validation was not performed, multiplier passed validation, multiplier failed validation, KH passed validation, KH failed validation, KE passed validation, KE failed validation, etc.

A ChangeMeterDataFlag element 1748 indicates if changes to the meter data have been made that would force validation to not be performed at the field device when the reading is entered. A ChangeMiscellaneousDataFlag element 1750 indicates if changes to miscellaneous data items in meter or meter session input have been made. A Code1 element 1752, a Code2 element 1754 and a Code3 element 1756 relate to particular problems associated with utility comment codes predefined by the system. A TroubleMessage element 1758 relates to a textual trouble description entered by the field worker to describe trouble for the work order. A MeterSessionOutputRF element 1760 relates to the RF output from a meter session input that was read via a RF link to the meter. A FieldWorkerElement 1762 provides an identifier for the field worker performing the meter session output functions. A FieldWorkerID element 1764 relates to the field worker ID for the field worker (or office worker if a reading was entered at a client workstation) that performed the reading. As a field worker can have multiple devices, a FieldDevice element 1766 relates to the type of field device possessed by the field worker during the reading. A FieldDeviceID element 1770 relates to the device ID for the device used to obtain the reading.

While the above examples provide details of one or more embodiments of the invention, one skilled in the art would recognize that any combination of elements/nodes may be used without departing from the scope of the invention. In addition, one skilled in the art would recognize that any of the above described elements/nodes may be omitted or are optional and that new elements/nodes may be added, modified, or otherwise configured in relation to the particular application or context. For example, other elements not shown or described here may be implemented without departing from the scope of the invention. In addition, the invention may be implemented without including one or more of the various elements and nodes illustrated here. With respect to any given element or node, there may be more than one instance or occurrence.

### CONCLUSION

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps or components are presented in a given order, alternative embodiments may perform routines having steps or components in a different order. The teachings of the invention provided herein may be applied to other systems, not necessarily the network communication system described herein. The elements and acts of the various embodiments described above may be combined to provide further embodiments, and some steps or components may be deleted, moved, added, subdivided, combined, and/or modified. Each of these steps may be implemented in a variety of different ways. Also, while these steps are shown as being performed in series, these steps may instead be performed in parallel, or may be performed at different times.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words in the above detailed description using the singular or plural number may also include the plural or singular number, respectively. Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The teachings of the invention provided herein may be applied to other systems, not necessarily the system described herein. These and other changes can be made to the invention in light of the detailed description. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

While the above description details certain embodiments of the invention and describes the best mode contemplated, no matter how detailed the above description appears in text, the invention can be practiced in many ways. Details of the system, data model, and management scheme may vary considerably in their implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

1. A computer-readable medium containing a schema definition used by a utility system and a supporting system that performs work for the utility system, the schema definition including:
a work set element definition relating to information about work performed by the supporting system;
a work element definition relating to information about functions supported by the supporting system;
a customer element definition relating to utility customer information;
a service point element definition relating to utility service point information for utility service points supported by the supporting system;
a meter element relating to meter information for utility meters supported by the supporting system;
a meter session input element relating to information for operations to be performed on utility meters supported by the supporting system;
a meter session output element relating to information for meter session output collected by the supporting system; and
wherein the schema definition is structured in accordance with an extensible markup language (XML) or XML-like data format that allows for the use of customized tags that enable the definition, validation, and interpretation of data communicated between the utility and the supporting system via an electronic data transmission channel, and wherein the data format is applicable across multiple applications and multiple electronic data transmission channels.

2. The computer-readable medium of claim 1 wherein the schema definition further includes a message element relating to information for displaying messages on electronic field devices associated with the supporting system.

3. The computer-readable medium of claim 1 wherein the schema definition further includes a codes element relating to information for codes supporting work performed by the supporting system.

4. The computer-readable medium of claim 1 wherein the schema definition is structured in accordance with extensible markup language (XML).

5. The computer-readable medium of claim 1 wherein the schema definition further includes a field service element relating to field service functions performed by the supporting system.

6. The computer-readable medium of claim 1 wherein the schema definition further includes an accounts element relating to customer account information.

7. At a supporting system that performs work for a utility system, a method for exporting information to the utility system, the method comprising:
identifying information to be sent to the utility system, wherein the identified information includes at least one of the following:
utility meter data,
field service results data, and
analytical data resulting from raw data analysis performed by the supporting system;
accessing a definition of a data format, wherein the data format allows for the use of customized tags that enable the definition, validation, and interpretation of data communicated between the utility and the supporting system via an electronic data transmission channel, and wherein the data format is applicable across multiple applications and multiple electronic data transmission channels;
based on the accessed definition, formatting the identified information to be sent to the utility system;
based on the accessed definition, validating the formatted information to be sent to the utility system; and
transmitting the validated information to the utility system.

8. The method of claim 7 wherein the identified information includes data collected by the supporting system that is configured for reports.

9. The method of claim 7 wherein the identified information includes vehicle statistic data collected by the supporting system in association with a mobile meter reading system.

10. The method of claim 7 wherein the identified information further includes field worker statistics.

11. At a utility system, a method for receiving data from a supporting system that provides information for the utility system, the method comprising:
receiving data from the supporting system,
wherein the received data includes at least one of the following:
utility meter data,
field service results data, and
analytical data resulting from raw data analysis performed by the supporting system, and
wherein the received data is configured in a data format,
wherein the data format allows for the use of customized tags that enable the definition, validation, and interpretation of data communicated between the utility and the supporting system via an electronic data transmission channel, and
wherein the data format is applicable across multiple applications and multiple electronic data transmission channels;
accessing a definition of the data format in which the received data is configured; and
based on the accessed definition, validating the received data.

12. The method of claim 11 further comprising interpreting the validated data using one or more data parsers that are specific to the data format defined in the accessed definition.

13. The method of claim 11 wherein the data is received in a file, and wherein the file is structured according to the data format defined in the accessed definition.

14. The method of claim 11 wherein the accessed definition includes information about acceptable ranges for the received data, and wherein the validating includes verifying that the received data falls within the acceptable ranges.

15. The method of claim 11 wherein the data format in which the received data is configured is structured in accordance with extensible markup language (XML).

16. The method of claim 11 wherein the data format in which the received data is configured is structured in accordance with hypertext markup language (HTML).

17. The method of claim 11 wherein the received data is received in a message queue.

18. At a utility system, a method for providing information to a supporting system that performs work for the utility system, the method comprising:
identifying information to be sent to the supporting system, wherein the identified information includes requests for work to be performed by the supporting system and supporting data to be used by the supporting system in completing the requests for work;
accessing a definition of a data format, wherein the data format allows for the use of customized tags that enable the definition, validation, and interpretation of data communicated between the utility and the supporting system via an electronic data transmission channel, and wherein the data format is applicable across multiple applications and multiple electronic data transmission channels;
based on the accessed definition, formatting the identified information to be provided to the supporting system; and
providing the formatted information to the supporting system.

19. The method of claim 18 wherein the identified information includes requests for analytical data to be provided by one or more analytical applications of the supporting system, and wherein the one or more analytical applications analyze data collected by the supporting system.

20. A supporting system that provides information for a utility system by a method for importing data from the utility system, the system comprising:
means for receiving from the supporting system, data configured in a format that allows for the use of customized tags that enable the definition, validation, and interpretation of data communicated between the utility and the supporting system via an electronic data transmission channel, and wherein the data format is applicable across multiple applications and multiple electronic data transmission channels, and wherein the data includes requests for work to be performed by the supporting system and supporting data to be used by the supporting system in completing the requests for work;
means for accessing a definition of the data format in which the received data is configured; and
means for validating the received data based on the accessed definition.

21. The system of claim 20 wherein the accessed definition includes information that allows the supporting system to structure one or more databases for storing the received information.

22. A computer-readable medium accessible by a supporting system configured for providing support to a utility system, the computer-readable medium containing a data structure comprising:
information to be imported by the supporting system, the information including:
a first type of information associated with work to be performed by the supporting system, and
a second type of information associated with supporting data to be used by the supporting system in performing the work; and
wherein the information to be imported by the supporting system is in a format that allows for the use of customized tags that enable the definition, validation, and interpretation of data communicated between the utility and the supporting system via an electronic data transmission channel, and wherein the data format is applicable across multiple applications and multiple electronic data transmission channels.

23. The computer-readable medium of claim 22 wherein the information to be imported by the supporting system further includes a message for display on an electronic field device associated with the supporting system.

24. The method of claim 22 wherein the information to be imported by the supporting system further includes one or more codes for supporting work to be performed by the supporting system.

25. The computer-readable medium of claim 22 wherein the information to be imported by the supporting system further includes information relating to specific work to be performed by the supporting system.

26. The computer-readable medium of claim 22 wherein the information to be imported by the supporting system further includes information relating to functions performed by the supporting system.

27. The computer-readable medium of claim 22 wherein the information to be imported by the supporting system further includes customer information.

28. The computer-readable medium of claim 22 wherein the information to be imported by the supporting system further includes customer account information.

29. The computer-readable medium of claim 22 wherein the information to be imported by the supporting system further includes information relating to utility service points supported by the supporting system.

30. The computer-readable medium of claim 22 wherein the information to be imported by the supporting system further includes information relating to utility meters supported by the supporting system.

31. The computer-readable medium of claim 22 wherein the information to be imported by the supporting system further includes information relating to operations to be performed on utility meters supported by the supporting system.

32. A computer-readable medium containing a data structure comprising:
data to be exported to a system of a utility service provider, wherein the data includes at least one of the following:
information related to customer usage of a utility provided by the utility service provider, and
field service data, wherein the field service data includes one or more of the following:
information related to maintenance of utility meters, and
environmental conditions of utility meters; and
wherein the data to be exported to the system of the utility service provider is structured for the use of customized identifiers that enable the definition, validation, and interpretation of data sent or received over a data channel using a protocol, and wherein the structure of the data is not specific to the data channel or the protocol.

33. The computer-readable medium of claim 32 wherein the data to be exported to a system of a utility service provider further includes information relating to work performed by a supporting system as requested by the utility service provider.

34. The computer-readable medium of claim 32 wherein the data to be exported to a system of a utility service provider further includes data relating to functions by a supporting system as requested by the utility service provider.

35. The computer-readable medium of claim 32 wherein the data to be exported to a system of a utility service provider further includes customer information.

36. The computer-readable medium of claim 32 wherein the data to be exported to a system of a utility service provider further includes customer account information.

37. The computer-readable medium of claim 32 wherein the data to be exported to a system of a utility service provider further includes new service data that provides information about new meters identified by a field worker on a meter reading route.

38. The computer-readable medium of claim 32 wherein the data to be exported to a system of a utility service provider further includes information relating to utility service points managed by a supporting system as requested by the utility service provider.

39. The computer-readable medium of claim 32 wherein the data to be exported to a system of a utility service provider further includes information relating to utility meters managed by a supporting system as requested by the utility service provider.

40. The computer-readable medium of claim 32 wherein the data to be exported to a system of a utility service provider further includes information relating to meter session output collected by performed by a supporting system as requested by the utility service provider.

41. The computer-readable medium of claim 32 wherein the data to be exported to a system of a utility service provider further includes information relating to changes in meter session input data provided by a field worker.

42. The computer-readable medium of claim 32 wherein the computer-readable medium is a node in a message queue receiving the contents.

43. The computer-readable medium of claim 32 wherein the computer-readable medium is a logical node in a computer network receiving the contents.

44. The computer-readable medium of claim 32 wherein the computer-readable medium is a computer-readable disk.

45. The computer-readable medium of claim 32 wherein the computer-readable medium is a data transmission medium transmitting a generated data signal containing the contents.

46. The computer-readable medium of claim 32 wherein the computer-readable medium is a memory of a computer system.

47. A supporting system that performs work for a utility system, the system comprising:
means for assembling information to be sent to the utility system, wherein the assembled information includes at least one of the following:
utility meter data, field service results data, and analytical data resulting from raw data analysis performed by the supporting system;
means for accessing a definition of a data format, wherein the data format allows for the use of customized tags that enable the definition, validation, and interpretation of data sent or received over an electronic data transmission channel, and wherein the data format is not specific to the electronic data transmission channel;
means for formatting the assembled information to be sent to the utility system based on the accessed definition;
means for validating the formatted information to be sent to the utility system based on the accessed definition; and
means for transmitting the validated information to the utility system.
